(19) United States
(12) Patent Application Publication
(10) Pub. No.: US 2013/0052614 A1
(43) Pub. Date: Feb. 28, 2013

(54) Driver Performance Metric

(71) Applicants: Daniel Joseph Mollicone, Philadelphia, PA (US); Kevin Gar Wah Kan, Philadelphia, PA (US); Damian Marcus Biondo, Philadelphia, PA (US); Christopher Grey Mott, Seattle, WA (US)

(72) Inventors: Daniel Joseph Mollicone, Philadelphia, PA (US); Kevin Gar Wah Kan, Philadelphia, PA (US); Damian Marcus Biondo, Philadelphia, PA (US); Christopher Grey Mott, Seattle, WA (US)

(73) Assignee: Pulsar Informatics, Inc., Philadelphia, PA (US)

(21) Appl. No.: 13/602,084

(22) Filed: Aug. 31, 2012

Related U.S. Application Data
(60) Provisional application No. 61/529,424, filed on Aug. 31, 2011.

(51) Int. Cl. G09B 9/04

(52) U.S. Cl. 434/65

(57) ABSTRACT

Systems and methods for quantifiable assessment of vehicle driver performance based upon objective standards are disclosed. The physical and/or control states of a vehicle are monitored by sensors during a driving trip. Measurement data, optionally comprising a measurement signal, is composed from parameters selected from the measured physical and/or control states. The measurement data is then compared to reference data, optionally comprising a reference signal, comprising the same or similar physical and control state parameters, for the same or analogous driving trip or portion thereof, including discrete driving tasks, as determined by one or more of: a known driver of specific attributes, a population average, or an autonomous driving algorithm. A metric of comparison may be determined as one or more characteristic metrics of a driving task, according to one or more path metrics of a driving task, or as a signal distance metric between the reference and measurement signals.

### RELATED APPLICATIONS

This application claims benefit of priority of U.S. application No. 61/529,424, filed Aug. 31, 2011.

### TECHNICAL FIELD

The presently disclosed invention relates to systems and methods for assessing the performance of a driver of a vehicle when compared to an established standard of performance.

### BACKGROUND

Performance assessment for drivers of vehicles has been conducted by qualitative and subjective judgment of one or more human agents observing a driver in a particular situation, or using blunt quantitative metrics. Subjective judgments have included collision risk, safety, adherence to road rules and/or the like, and general metrics have included fuel consumption or collision occurrences. Human observation may be expensive and impractical for some applications, and general metrics may not take in account details of the actual driving conditions encountered by the driver. There is a need for systems and methods that determine quantitative driver performance relative to a standard of performance matched to the particular situation in which the driver is operating.

### SUMMARY

Among its many aims and objectives, the presently disclosed invention seeks to provide an objective and quantitative assessment of a driver's performance on one or more driving tasks or one or more driving trips. One particular aspect of the invention provides a method, using a computer, for assessing driver performance relative to a standard of performance, the method comprising: receiving measurement data at a computer, the measurement data indicative of one or more vehicle state parameters corresponding to a driver operating the vehicle during a driving trip; receiving reference data at the computer, the reference data indicative one or more vehicle state parameters corresponding to a standard of performance for the vehicle during at least a portion of the driving trip; and determining, at the computer, a metric of comparison based at least in part on the received measurement signal and the received reference data, the metric of comparison indicative of an assessment of the driver operating the vehicle relative to the standard of performance.

Another particular aspect of the invention provides a computer program product embodied in a non-transitory medium and comprising computer-readable instructions that, when executed by a suitable computer, causes the computer to perform a method for assessing driver performance relative to a standard of performance, the method comprising; receiving measurement data at a computer, the measurement data indicative of one or more vehicle state parameters corresponding to a driver operating the vehicle during a driving trip; receiving reference data at the computer, the reference data indicative one or more vehicle state parameters corresponding to a standard of performance for the vehicle during at least a portion of the driving trip; and determining, at the computer, a metric of comparison based at least in part on the received measurement signal and the received reference data, the metric of comparison indicative of an assessment of the driver operating the vehicle relative to the standard of performance.

Another particular aspect of the invention provides a system for assessing driver performance relative to a standard of performance, the system comprising: a measurement signal generator, the measurement signal generator being capable of generating a measurement signal that provides measured values for one or more parameters of a vehicle's state while a driver is operating the vehicle on a driving trip; a reference signal generator, the reference signal generator being capable of generating a reference signal that, for at least a portion of the driving trip, provides values for one or more parameters of a vehicle's state while it is being driving in accordance with a standard of performance; and a scorer, the scorer being capable of determining a metric of comparison between the reference signal and the measurement signal, the metric of comparison being indicative of how the driver executed the one or more driving tasks with the vehicle relative to the standard of performance, wherein the scorer is communicably connected to the reference signal generator and the measurement signal generator such that the scorer receives the reference signal and the measurement signal.

### BRIEF DESCRIPTION OF THE DRAWINGS

The multiple views of FIG. 1 graphically depict the “state” of a moving vehicle, in accordance with certain embodiments, particularly in which:

FIG. 1A illustrates the physical state of a moving vehicle;

FIG. 1B illustrates the control state of a moving vehicle; and

FIG. 1C illustrates various sensors and signals used to measure the vehicle control state in accordance with a particular illustrative and non-limiting embodiment;

The multiple views of FIG. 2 illustrate the concept of “environmental factors” in accordance with certain embodiments, particularly in which:

FIG. 2A graphically depicts a hypothetical driving scenario and identifies relevant from irrelevant environmental factors; and

FIG. 2B depicts an automobile equipped with sensors capable of detecting environmental factors;

FIG. 3 illustrates the concept of a “driving task” and a “standard of performance” in accordance with particular embodiments;

The multiple views of FIG. 4 provide flowcharts illustrating various processes used in accordance with particular embodiments, particularly in which:

FIG. 4A provides a flowchart for a general method 400 to determine a metric of comparison from reference data and measurement data, in accordance with particular embodiments;

FIG. 4B provides a flowchart for a method 410 to determine a metric of comparison in the form of a driving-task characteristic distance, in accordance with particular embodiments;

FIG. 4C provides a flowchart for a method 430 to determine a metric of comparison in the form of a driving task path distance, in accordance with particular embodiments; and

FIG. 4D provides a flowchart for a method 450 to determine a metric of comparison in the form of a signal distance, in accordance with particular embodiments;

FIG. 5 illustrates how a driving trip can be analyzed into a set of driving tasks, in accordance with particular embodiments; and

FIG. 6 provides a functional unit diagram for a non-limiting exemplary system capable of determining a driver performance metric, in accordance with particular embodiments.

### DETAILED DESCRIPTION

Throughout the following discussion, specific details are set forth in order to provide a more thorough understanding of the disclosed invention. The invention, however, may be practiced without these particulars. In other instances, well-known elements have not been shown or described in detail to avoid unnecessarily obscuring the invention. Accordingly, the specification and drawings are to be regarded in an illustrative rather than a restrictive sense.

Background to Driver Performance Measurement

Analysis of driver performance may be of importance to many industries, including transportation, law enforcement, insurance, and healthcare, among others. Assessing a degree to which a commercial truck driver is operating his vehicle in an efficient, safe and alert (i.e., non-fatigued) state may be useful for optimizing operational objectives such as safety, on-time delivery, and fuel efficiency. Quantitatively assessing driver performance in actual road conditions however, is not always a simple task, often requiring interpretation of both vehicle state and environmental factors.

Among its many aims and objectives, the presently disclosed invention provides a method to assess the driving performance of an individual driver based on a quantitative comparison to driving reference data that represent one or more standards of driving performance for particular driving trips or driving tasks. According to particular embodiments, driver performance is measured using one or more sensors to monitor the vehicle's physical state, the vehicle's control state, and vehicle's environment. According to particular embodiments, measurement data may be assembled into a signal (possibly comprising, without limitation, a set of time series functions) or other processed composite and then compared to reference data reflecting a standard of performance for the driving trip or driving task reflected in the measurement data.

Comparisons may be performed multiple times during a driving trip, and may be associated with a time stamp, in accordance with particular embodiments. Other embodiments determine a metric of comparison for an entire trip or for a single portion thereof. According to some embodiments, one or more comparisons of the measurement data and the reference data may be processed into a performance metric for either the entire driving trip or one or more portions thereof including, without limitation, one or more driving tasks comprising the driving trip. In some embodiments, the performance metric may then be further processed to determine various quantities derived therefrom, including but not limited to collision risk and/or insurance risk, fatigue level, driver skill level, driver personality, driver fuel-consumption pattern, one or more law enforcement parameters (e.g., whether driver was speeding, ran a red light, or was driving recklessly, etc.) and/or the like.

Vehicle Physical State Vs. Vehicle Control State

When considering driver performance, measurement and reference data may be drawn from the vehicle and its operative systems. According to particular embodiments, measurements of a vehicle state may fall within two general categories: the vehicle physical state and the vehicle control state.

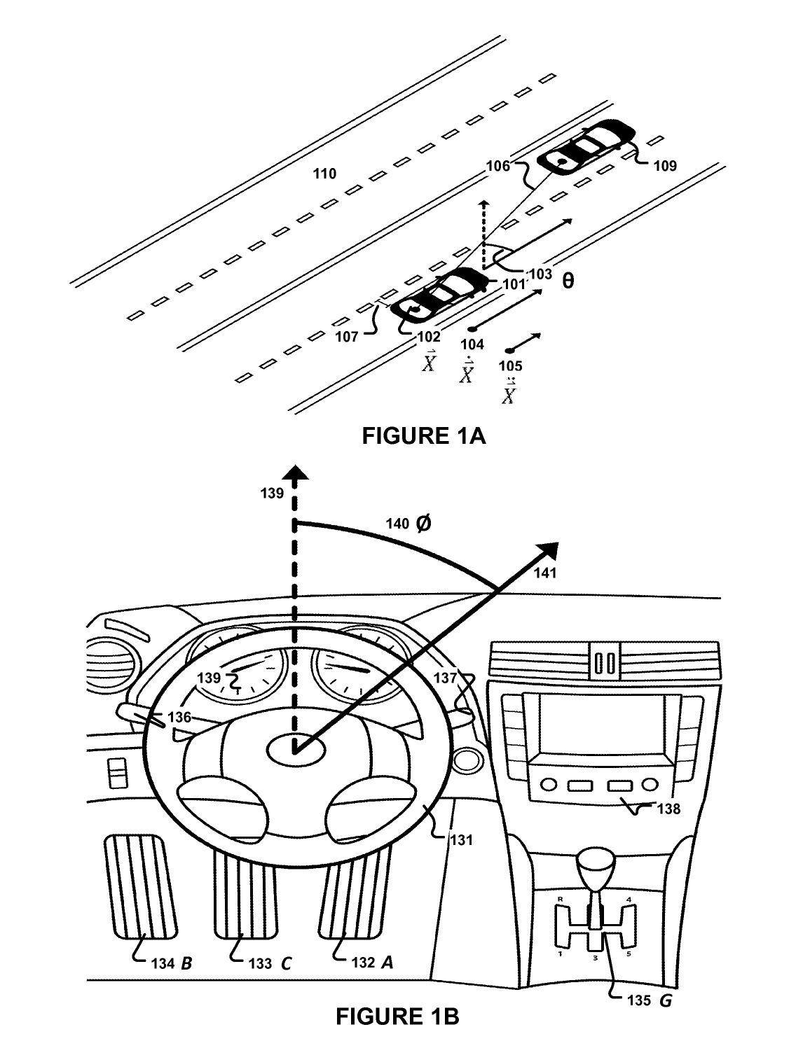

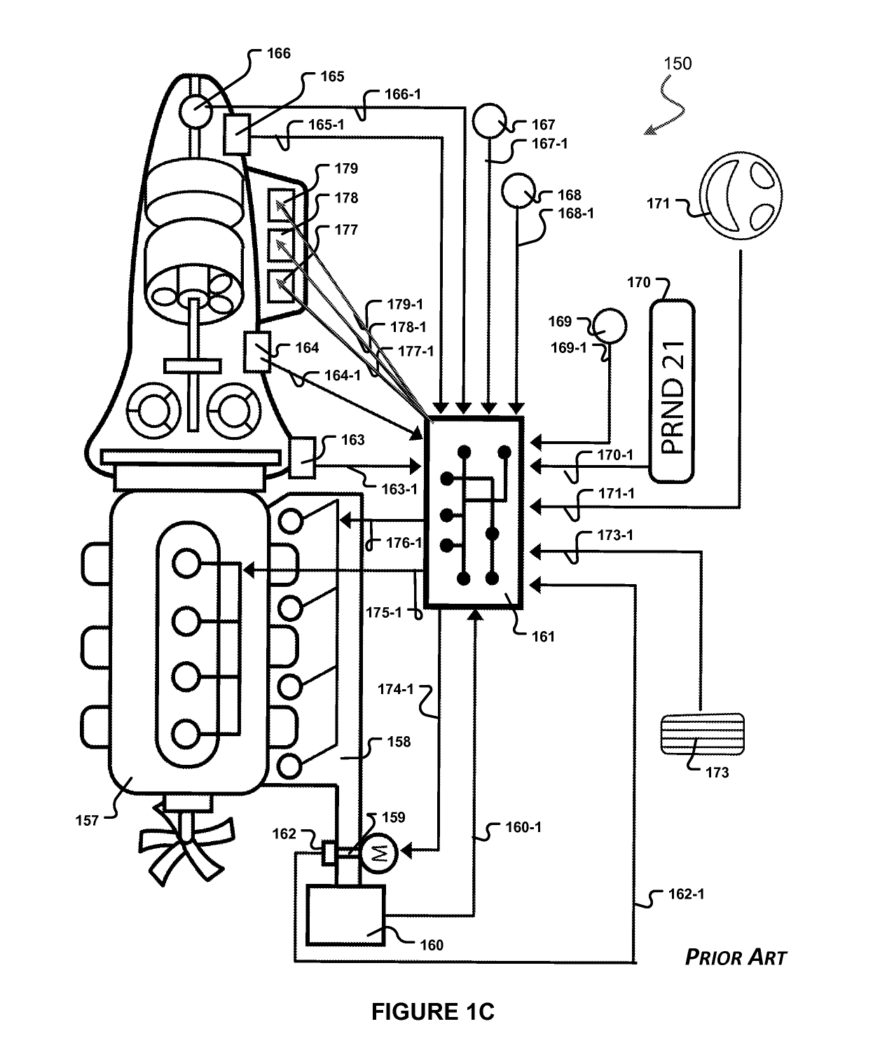

FIG. 1A provides a graphical illustration of the physical state of a vehicle 101. As used in the present discussion the term “vehicle physical state” (or simply “physical state”) refers to the overall physical characteristics of a vehicle, such as vehicle 101, principally as viewed from an external observer. Among these characteristics, but without limitation, are the vehicle's kinematic states, namely: the vehicle's position \vec{X} 102 (in three dimensions, measured by a fixed point on vehicle 101), its orientation 103 (also in three dimensions—the so-called Euler angles of pitch, roll, and yaw, or their equivalents—collectively referred to as \vec{θ}—which in particular embodiments may be limited to yaw for simplicity, since pitch and roll will largely be determined by road topologies), any number of time derivatives thereof, and/or the like. Particular embodiments will be chiefly concerned with the first two time derivatives of position, in three dimensions, namely velocity {right arrow over (\dot{X} 104 and acceleration {right arrow over (\ddot{X} 105, represented as vectors in FIG. 1A. Quantifying particular subsets of the foregoing physical characteristics may suffice to describe (in whole or in part) the vehicle's physical state.

Measurements of kinematic physical state parameters may be derived by any number of sensor systems, including without limitation the vehicle's speedometer, an on-board accelerometer, GPS technologies, cameras and video cameras (both on-board on external to the vehicle), radar, proximity sensors, and/or the like.

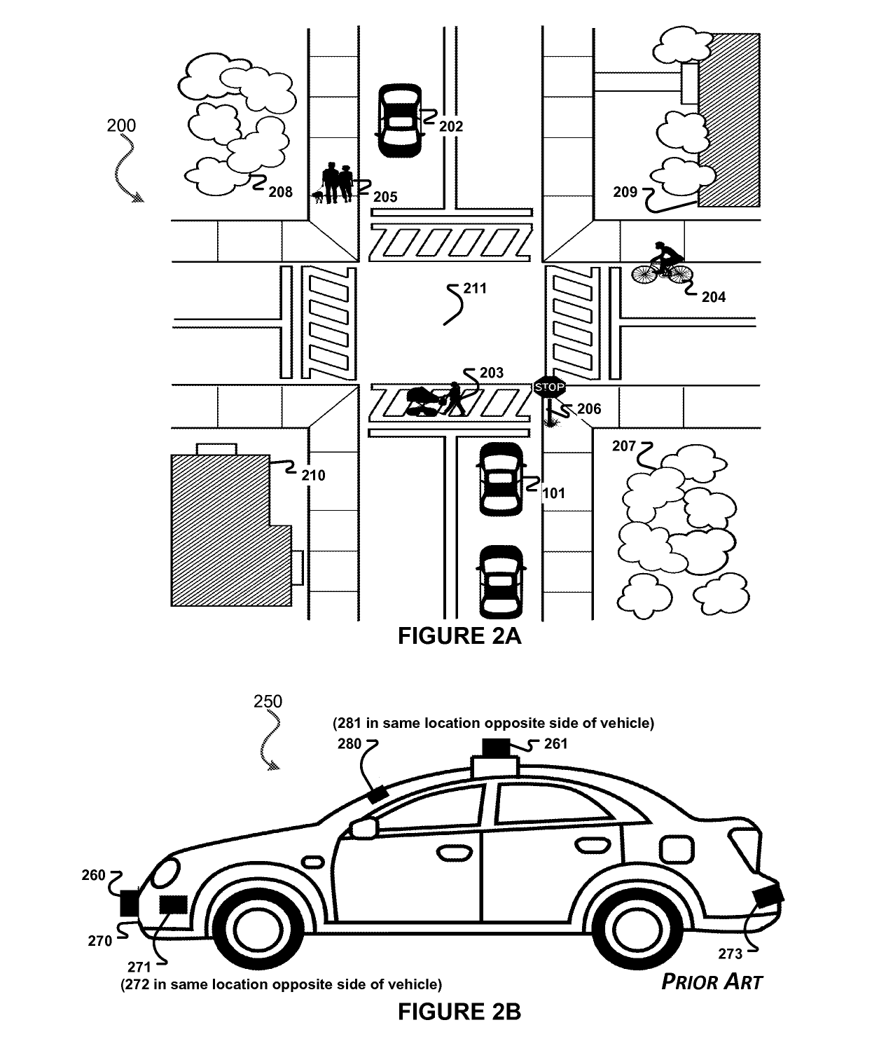

In some embodiments of the invention, contextual physical state parameters may also be determined. Contextual physical state parameters describe physical parameters of vehicle 101 relative to its environmental context—such as, without limitation, the lane position 107 (shown as distance to nearest lane divider line 109), proximity to a collision risk 108 (shown as distance to another vehicle 110), location in a zone of danger (not shown), and/or the like. According to particular embodiments, contextual physical state parameters may be determined in conjunction with one or more environmental factors and may be determined using environmental-factor data, as discussed more fully below, in connection with the multiple views of FIG. 2.

Measurement of each of these physical state parameters may occur through a variety of systems and technologies, discussed below in connection with FIG. 1C. Table 1, provides a symbolic system for describing the foregoing parameters of a vehicle's physical state, and lists different measurement techniques and conversion formulas, also discussed below in connection with FIG. 1C. The symbolic system of FIG. 1A may be used, in accordance with particular embodiments, for describing the measurement and reference data (including reference and measurement signals) in formal mathematical terms (see, e.g., the various signal formulas of Table 2A).

TABLE 1A
Vehicle Physical State Parameters

| | Parameter | Control | | |
|---|---|---|---|---|
| | Name | Symbol | Measurement Techniques | Conversion Techniques |
| KINEMATIC | Position | [symbol] | GPS | n/a |
| | | | External camera (still or video) | Image and video |
| | | | | analysis |
| | | | Radar | Determine position |
| | | | | with reference to a |
| | | | | fixed object |
| | Orientation | [symbol] | GPS | Analysis of travel path |
| | | | Compass | n/a |
| | | | External camera (still or video) | Determine orientation |
| | | | | with reference to a |
| | | | | fixed object |
| | Angular Velocity | [symbol] | Gyroscope | |
| | Velocity | [symbol] | Speedometer | Combine speed with |
| | | | | orientation to get |
| | | | | velocity. |
| | | | External video camera | Determine velocity |
| | | | | with reference to a |
| | | | | fixed object |
| | | | GPS | Analysis of travel path |
| | | | Accelerometer | Integrate speedometer |
| | | | | and orientation over |
| | | | | time and add to known |
| | | | | initial velocity |
| | Acceleration | [symbol] | Speedometer | Determine rate of |
| | | | | change of speed and |
| | | | | orientation |
| | | | Accelerometer | n/a (use multi-axis |
| | | | | accelerometer) |
| | | | GPS | Analysis of travel path |
| CONTEXTUAL | Lane Position | L | External camera (still or video) | n/a |
| | | | Car-mounted camera (still or video) | n/a |
| | Collision | N | External camera (still or video) | n/a |
| | Proximity | | Car-mounted camera (still or video) | n/a |
| | | | Car-mounted laser | n/a |

Multiple measurements (either measurements from multiple sensors or several measurements from the same sensor over a period of time) can be combined to improve the accuracy, precision, and reliability of measurements of the vehicle's physical state and any signals derived therefrom. For example, location measurements using only GPS measurements are accurate to within several feet (with accuracy depending, e.g., on the number of visible GPS satellites). A set of inertial measurements—such as vehicle speed, acceleration, steering, and direction of travel—may be used to estimate vehicle positioning based on dead-reckoning by appropriately integrating such measurements over time in conjunction with known initial or boundary conditions. By using a Kalman filter, for example, the GPS and inertial measurement can lead to determining the vehicle's location with greater precision than with GPS alone. Likewise, estimates of other vehicle physical and control parameters can be made by combining measurements collected over time and across multiple sensors. In addition to Kalman filters, unscented Kalman filters, Bayesian data fusion techniques, various Monte Carlo techniques, and/or the like may also be applied, according to particular embodiments, to combine measurements from more than one sensor or other data source (e.g., a database, user input, etc.)

FIG. 1B provides a graphical illustration of the control state of vehicle 101. As used herein, the term “vehicle control state” (or simply “control state”) refers to the state of one or more of the inputs that is typically provided by a driver to control system of the vehicle. Without limitation, the control state of a vehicle comprises the state of the control systems which a driver may impact, manipulate, change, or otherwise affect while engaging in a driving trip, while executing a driving task, or while otherwise operating a vehicle. A vehicle control state may be categorized as indicative of either a critical or subsidiary control system. Critical control systems include, without limitation, the vehicle steering mechanism (such as the steering wheel 131, shown), the vehicle's acceleration system A (such as the accelerator pedal 132, shown), and the vehicle's driving brake mechanism B (such as the driving brake pedal 133, shown).

When using the identified mechanisms 131, 132, 133, measurement of each of these critical control systems occurs with respect to an identified baseline, such as the location, orientation, or status of the mechanism 131, 132, 133 while the vehicle is at rest, or with respect to a minimum, maximum, or other arbitrary location, orientation or status of the mechanism. As one non-limiting example, orientation 141 of the steering wheel 131, is measured by noting the magnitude of the orientation angle 140, (denoted Ø) between the rest state 139 and current state 141 of the steering wheel 131, represented by corresponding vectors in FIG. 1B. Similar techniques (not shown) may be used, according to particular embodiments, for the accelerator pedal 132 and the driving brake pedal 133. One or more of these primary vehicle control inputs may be monitored, according to particular embodiments.

In some embodiments, additional secondary vehicle control systems may be monitored as well, and include but are not limited to turn signals 136, clutch 134 and gearing 135 systems, windshield wipers 137, audiovisual or entertainment systems 138, fuel gauge 139, and/or the like. Table 1B likewise provides a list of control state parameters (classified as primary or secondary), and techniques for their direct and indirect measurement and conversion from measurements to control state, in accordance with particular embodiments. The symbolic system of FIG. 1B may be used, in accordance with particular embodiments, for describing the measurement and reference data (including reference and measurement signals) in formal mathematical terms (see, e.g., the various signal formulas of Table 2B).

TABLE 1B
Vehicle Control State Parameters

| | Control | Control | | |
|---|---|---|---|---|
| | Name | Symbol | Measurement Techniques | Conversion Techniques |
| PRIMARY | Steering | Ø | Angle of steering wheel | Default measured value |
| | Wheel | | Angle of orientation of wheels of vehicle | Convert wheel orientation to |
| | Angle | | | steering wheel orientation |
| | | | Orientation of the vehicle (as measured by | Convert vehicle orientation (and first |
| | | | GPS, on-board compass, etc.) (same as Θ, | or second time derivative) to |
| | | | above, from Table 1A) | steering wheel orientation |
| | Accelerator | A | Accelerometer | Convert displacement of accelerator |
| | Pedal | | | pedal from resting position to |
| | Position | | | acceleration of vehicle. |
| | | | Speedometer | Rate of change of speedometer |
| | | | | reading (first derivative) |
| | | | Displacement of accelerator pedal from | Default measured value |
| | | | resting position | |
| | | | Throttle aperture width/area | Convert magnitude of throttle |
| | | | | opening to acceleration of vehicle |
| | | | Volume of fuel passing through injector or | Convert volume of fuel passing |
| | | | throttle | through throttle to acceleration of |
| | | | | the vehicle |
| | Driving | B | Accelerometer | Convert deceleration of the vehicle |
| | Brake | | | to displacement of the brake pedal |
| | Position | | | from resting position. |
| | | | Speedometer | Rate of change of speedometer |
| | | | | reading (negative first derivative) |
| | | | Displacement of brake pedal from resting | Default measured value |
| | | | position | |
| | | | Pressure on brake disk | Disk brake monitor |
| | Clutch | C | Whether engaged or not (binary value) | N/A |
| | (optional) | | | |
| | Gear | G | Which gear engaged (integer value from 0 | N/A |
| | Shifter | | to 6 or so, with 0 being reverse) | |
| | (optional) | | | |
| SECONDARY | Left Turn | T_{L} | Whether engaged or not (binary value) | N/A |
| | Signal | | | |
| | Right Turn | T_{R} | Whether engaged or not (binary value) | N/A |
| | Signal | | | |
| | Hazard | H | Whether engaged or not (binary value) | N/A |
| | Lights | | | |
| | Windshield | W | Whether engaged or not (binary value) | N/A |
| | Wipers | | | |
| | Radio | R | Whether engaged or not (binary value) | N/A |
| | Parking | P | Whether engaged or not (binary value) | N/A |
| | Brake | | | |
| | Fuel Gauge | F | Percentage of fuel tank capacity remaining | N/A |

FIG. 1C illustrates additional internal vehicle systems that may be used to determine and/or measure the control state of a vehicle 101, in accordance with a non-limiting embodiment comprising a vehicle with an automatic-transmission controller system 150 with accompanying vehicle sensors and corresponding vehicle sensor signal components. Exemplary and non-limiting automatic-transmission controller system 150 is based, without limitation, on an exemplary disclosure from U.S. Pat. No. 5,960,560, issued to Minowa et al. on May 25, 1999, entitled “Power Train Controller and Controller Method,” and assigned to Hitachi Ltd., the entirety of which is hereby incorporated herein by reference. Similar controller systems as are known in the art may be utilized by particular embodiments of the presently disclosed invention.

Exemplary controller system 150 comprises a throttle valve 159 installed on an air suction pipe 158 of a vehicle combustion engine 157, equipped with an air flow meter 160, which provides a corresponding air-flow signal 160-1, which is input to control unit 161. Throttle angle signal 162-1, engine speed signal 163-1, turbine speed signal 164-1, vehicle speed signal 165-1, torque signal 166-1, driven wheel speed signal 167-1, drive wheel speed signal 168-1, acceleration signal 169-1, shift position signal 170-1, steering wheel angle signal 171-1, and flow meter angle signal 173-1 are detected and produced by throttle angle sensor 162, engine speed sensor 163, turbine speed sensor 164, wheel speed sensor 165, torque sensor 166, driven wheel speed sensor 167, drive wheel speed sensor 168, acceleration sensor 169, shift position switch 170, steering wheel angle sensor 171, and flow meter angle sensor 173, respectively. These control sensor signals are input to the control unit 161, and target throttle angle 174-1, fuel injection width 175-1, firing period 176-1, lockup duty 177-1, speed change ratio 178-1 and hydraulic duty 179-1 are output from control unit 161 to electronic control throttle 174, fuel injection valve 175, firing unit 176, lockup control solenoid 177, speed change point control solenoid valve 178, and clutch operation pressure control solenoid 179, respectively.

The control state of vehicle 101 may be determined, in accordance with particular embodiments, by reference to any one or more of sensor signal components 160-1 through 173-1 as determined by any one or more of corresponding sensors 160-1 through 173-1. Sensor signal components may be used individually or in any combination as a component of a signal \vec{S}(t) as used in the presently disclosed invention either in modified or unmodified forms. Steering wheel sensor signal 171-1, for example, may be used for steering wheel angle signal component Ø, as discussed in connection with Table 1B, in an unmodified format. Throttle angle signal 161-1, however, may need to be modified, adjusted and/or translated before it can be used as a signal component corresponding to the vehicle's acceleration. Various techniques and formulas, well known to those of ordinary skill, may be applied to sensor signal components 1601-1 through 173-1 to create one or more components of signal \vec{S}(t).

Environmental State

Factors extrinsic to the vehicle—and therefore beyond the immediate and direct scope of the vehicle physical state or vehicle control state—often significantly impact the driver's awareness and/or decision process and, by direct implication, his or her driving performance. Such factors are referred to herein as “environmental factors” and may be further classified as relevant or irrelevant environmental factors. FIG. 2A provides a graphical illustration of a hypothetical driving scenario 200, in which vehicle 101 approaches a city intersection 211. Hypothetical scenario 200 also comprises additional vehicles 201, 202 on the roadway 212. All vehicles 101, 201, 202 are waiting their turn at a stop, identified to vehicle 101 by traffic (stop) sign 206. Intersection 211 is also populated with several pedestrians 203, 205 and a cyclist 204. Each of the foregoing elements 201, 202, 203, 204, 205, 206 could potentially impact—to some degree or another—the driving behaviors of a driver of vehicle 101. For this reason, particular embodiments would consider these elements 201, 202, 203, 204, 205, 206 as “relevant environmental factors.” Other relevant environmental factors may also comprise temperature and climate conditions (not shown), and/or the like. Conversely, certain elements must be identified as not having a particular impact on the behavior of the driver. So-called “irrelevant environmental factors” include, without limitation, objects well off the roadway 203 such as trees 207, 208, and buildings 209, 210.

FIG. 2B illustrates an exemplary and non-limiting vehicle 250 equipped with sensor equipment, such as lasers, radar detection, various cameras, and/or the like, used in particular embodiments, for identifying environmental factors (both relevant and irrelevant). Exemplary and non-limiting vehicle 250 is based, without limitation, on a disclosure from International Patent Application No. PCT/US2011/054154 (WIPO Publication No. WO 2012/047743) submitted by Montemerlo et al. on Sep. 30, 2011, entitled “Zone Driving” and issued to Google, Inc., the entirety of which is hereby incorporated herein by reference. Similar sensor-equipped vehicles as are known in the art may be utilized by particular embodiments of the presently disclosed invention.

As shown in FIG. 2B, sensor-equipped vehicle 250 may include lasers 260, 261, mounted on the front and top of the vehicle 250, respectively. The lasers 260, 261 may provide the vehicle 250 with range and intensity information which the presently disclosed invention may utilize to identify the location and distance of various objects. In particular embodiments, lasers 260, 261 may measure the distance between the vehicle 250 and object surfaces facing the vehicle by spinning on its axis and changing its pitch.

The vehicle 250 may also include various radar detection units 270, 271, 272, 273, such as those used for adaptive cruise control systems. The radar detection units 270, 271, 272, 273 may be located on the front and back of the vehicle 250 as well as on either side of the front bumper. As shown in the example of FIG. 2B, and in accordance with a particular embodiment, vehicle 250 includes radar detection units 270, 271, 272, 273 located on the side (only one side being shown), front and rear of the vehicle, respectively.

In another example, a variety of cameras 280, 281 may be mounted on sensor-equipped vehicle 250. The cameras 280, 281 may be mounted at predetermined distances so that the parallax from the images of two (2) or more cameras may be used to compute the distance to various objects. As shown in FIG. 2B, vehicle 250 is equipped with two (2) cameras 280, 281 mounted under a windshield near the rear view mirror (not shown).

The aforementioned sensors 260, 261, 270, 271, 272, 273, 280, 281 may allow the vehicle to evaluate and potentially respond to its environment—through the collection of environmental-factor data, that may or may not comprise one or more time series functions of environmental factors—in order to maximize safety for the driver, other drivers, as well as objects or people in the environment. It will be understood that the vehicle types, number and type of sensors, the sensor locations, the sensor fields of view, and the sensors' sensor fields are merely exemplary. Various other configurations may also be utilized. In addition to the sensors described above, the computer may also use input from sensors found on more typical vehicles. For example, these sensors may include tire pressure sensors, engine temperature sensors, brake heat sensors, break pad status sensors, tire tread sensors, fuel sensors, oil level and quality sensors, air quality sensors (for detecting temperature, humidity, or particulates in the air), and/or the like. Many of these sensors provide data that is processed in real-time—i.e., the sensors may continuously update their output to reflect the environment being sensed at or over a range of time, and continuously or as-demanded provide that updated output for determining whether the vehicle's 250 then-current direction or speed should be modified in response to the sensed environment as part of the reference data, in accordance with particular embodiments.

Signals: Measurement Signals Vs. Reference Signals

According to particular embodiments, analysis of driver performance is conducted by assembling one or more measured vehicle state parameters into measurement data, and preferably (without limitation) a measurement signal, and then comparing the measurement data to reference data (including, without limitation, preferably a reference signal) composed of the same (or similar) parameters but reflecting a standard of performance for the same driving task or trip. The term “signal” as used throughout the present discussion refers a time-series function \vec{S}(t) of one or more physical or control state parameters that are sufficient to describe, at least in part, a vehicle's motion through a driving trip.

According to particular embodiments, signals may be either a “measurement signal” or a “reference signal.” Measurement signals \vec{S}_{M}(t) are signals composed of vehicle state parameters that are measured from an actual drivers' execution of a driving trip. Measurement signals are composites generated from the various measurement instrumentalities discussed in connection with the multiple views of FIG. 1. Conversely, a “reference signal” \vec{S}_{R}(t) is a signal—either hypothetical or real—that describes how to execute a driving trip according to some performance standard. As discussed more fully below, reference signals may be derived from one or more sources, including, without limitation, autonomous driving algorithms, statistical analysis of driver population studies, measurement of a driver of known competence, through physics and engineering calculations designed to optimize particular features (e.g., fuel economy, collision risk reduction, etc.), and/or the like.

Tables 2A and 2B illustrate different constructions of the measurement and reference signals according to different embodiments, wherein an assortment of components may be configured together to form a signal. It is important to note that the signal configurations listed in Tables 2A and 2B can be used for both measurement of actual driver performance and for description of reference signals used as the standard of measure for performance. Other signal configurations may be possible, according to particular embodiments, and neither the reference data nor the measurement data is required to be in signal format.

TABLE 2A
Exemplary Signals Based on Vehicle Physical State Parameters

| | |
|---|---|
| Signal comprising vehicle | [symbol] (t) = { [symbol] (t), [symbol] (t)} |
| position and orientation | |
| Signal comprised of kinematic | [symbol] (t) = { [symbol] (t), [symbol] (t), [symbol] (t), [symbol] (t) [symbol] (t)} |
| states (position, orientation, | |
| and time derivatives) | |
| Signal comprised of secondary | [symbol] (t) = {L(t), N(t)} |
| non-kinematic variables (lane | |
| deviation, distance to forward object) | |
| Signal comprised of kinematic | [symbol] (t) = { [symbol] (t), [symbol] (t), [symbol] (t), [symbol] (t), |
| states and secondary non- | [symbol] (t), L(t), N(t)} |
| kinematic vehicle states | |

From a purely physical-state perspective, a signal may comprise, according to particular embodiments, a time-series function of merely the kinematic physical state parameters—i.e., only a position component and an orientation component—such as:

\vec{S}(t)={\vec{X}(t),\vec{Θ}(t)} (1)

According to other embodiments, a signal may also be comprised of any combination of the aforementioned components along with one or more time derivatives of them. According to yet other embodiments, a signal may also comprise one or more components taken from the assortment of contextual physical state parameters (see Table 1A), such as lane position, collision risk, and/or the like. Table 2A provides several embodiments of signals that use vehicle control state parameters as described in connection with FIG. 1A and as listed in Table 1A.

Conversely, from the purely control-state perspective, a control signal may comprise a time-series function of merely the critical control system parameters—i.e., only the steering-wheel orientation, the accelerator mechanism state, and the braking mechanism state—such as:

\vec{S}(t)={Ø(t),A(t),B(t)} (2)

Likewise, according to other embodiments, a signal may also comprise one or more time derivatives of these components and/or one or more signal components taken from the assortment of secondary control state parameters (see Table 1B), such as, without limitation, clutch status, gear shifter status, left turn signal status, right turn signal status, hazard light status, windshield wiper status, radio (or other entertainment system) status, parking brake status, fuel gauge status, and or the like. Yet other embodiments may involve constructing signals using one or more of the engine control system parameters discussed in connection with FIG. 1C—including, without limitation, throttle angle signal 162-1, engine speed signal 163-1, turbine speed signal 164-1, vehicle speed signal 165-1, torque signal 166-1, driven wheel speed signal 167-1, drive wheel speed signal 168-1, acceleration signal 169-1, shift position signal 170-1, steering wheel angle signal 171-1, flow meter angle signal 173-1, target throttle angle 174-1, fuel injection width 175-1, firing period 176-1, lockup duty 177-1, speed change ratio 178-1, hydraulic duty 179-1, and/or the like. Table 2B provides several (non-limiting) embodiments of signals that use vehicle control state parameters as described in connection with FIG. 1B and as listed in Table 1B.

TABLE 2B
Exemplary Signals Based on Vehicle Control State Parameters

| | Automatic Transmission | Manual Transmission |
|---|---|---|
| Signal comprised of | [symbol] (t) = {Ø(t), A(t), B(t)} | [symbol] (t) = {Ø(t), A(t), B(t), C(t), G(t)} |
| primary controls | | |
| Signal comprised of | [symbol] (t) = {Ø(t), A(t), B(t), Ø′(t), A′(t), B′(t)} | [symbol] (t) = {Ø(t), A(t), B(t), Ø′(t), A′(t), |
| primary controls and | | B′(t), C(t), G(t)} |
| their time | [symbol] (t) = {Ø(t), A(t), B(t), Ø′(t), A′(t), B′(t), | [symbol] (t) = {Ø(t), A(t), B(t), Ø′(t), A′(t), |
| derivatives | Ø″(t), A″(t), B″(t)} | B′(t), Ø″(t), A″(t), B″(t), C(t), G(t)} |
| Signals comprised of | [symbol] (t) = {T_{L}(t), T_{R}(t), H(t), W(t), R(t), P(t), O(t)} | [symbol] (t) = {Ø(t), A(t), B(t), C(t), G(t), T_{L}(t), |
| secondary controls | | T_{R}(t), H(t), W(t), R(t), P(t), O(t)} |
| Signal comprised of | [symbol] (t) = {Ø(t), A(t), B(t), Ø′(t), A′(t), B′(t), | [symbol] (t) = {Ø(t), A(t), B(t), Ø′(t), A′(t), |
| combination of | Ø″(t), A″(t), B″(t), T_{L}(t), T_{R}(t), H(t), | B′(t), Ø″(t), A″(t), B″(t), C(t), |
| primary signal, time | W(t), R(t), P(t), O(t)} | G(t), T_{L}(t), T_{R}(t), H(t), W(t), |
| derivatives, and | | R(t), P(t), O(t)} |
| secondary controls | | |

Neither a purely physical-state nor a purely control-state perspective is required by the presently disclosed invention, and according to particular embodiments, signals may be composed of any combination of the foregoing physical state parameters and control state parameters.

It must be noted, furthermore, that the use of signals—specifically understood as sets of one or more time-series functions corresponding, at least in part, one or more vehicle state parameters—may be considered merely as a preferred mode of the presently disclosed invention, but not a strict requirement. The disclosed invention may operate on more generally broad conceptions of data, such as through use of reference data and measurement data that is not configured into time-series functions comprising signals as so understood. Such embodiments may use any data format as is common in the art, including, without limitation, as individual data fields, multi-field data records, vectors, arrays, lists, linked lists, queues, stacks, trees, graphs, and/or the like. In such embodiments, the reference data and the measurement data comprise data elements that correspond to one or more of the foregoing vehicle state parameters, just as described in connection with measurement signals and reference signals above. According to particular embodiments, data received from any of the foregoing sensors may be processed, stored, retrieved, transmitted, and/or manipulated in any manner before being subjected to the processes of the presently disclosed invention. In light of a possible preference for a signal-based embodiment of the presently disclosed invention, however, the present and foregoing discussion will assume the use of an embodiment in which signals comprising time-series functions are utilized as the preferred embodiment for measurement data and reference data. This assumption, however, is made only for the sake of convenience and clarity, and is not to be understood as an essential or otherwise limiting feature of the presently disclosed invention or of the appended claims.

Sources of Reference Signals

According to particular embodiments of the presently disclosed invention, reference signals may be generated in a variety of ways. According to one set of particular embodiments, the reference signal is generated in accordance with technology used to execute autonomous driving vehicles. Autonomous driving technologies (more fully discussed below) are deployed to monitor external driving conditions and then guide a vehicle in accordance with the demands presented. The manner in which an autonomous driving vehicle is navigated through one or more driving tasks (or continuous set of driving scenarios) can be used as a reference signal for the presently disclosed invention.

Other embodiments use reference signals generated by measurement and processing of the performance of actual human drivers. In one set of such embodiments, a driver of known status—e.g., of known driving experience or competence, racing expertise, fatigue level, reaction time, vision grade, intoxication level, etc.—is selected to perform a set of driving tasks in a test vehicle while measurements are taken of his or her operation of the vehicle controls (or of the vehicle's physical state parameters during operation of the vehicle). This set of measurements, which may be taken more than once and then combined in any statistically relevant fashion, then becomes the reference signal according to particular embodiments.

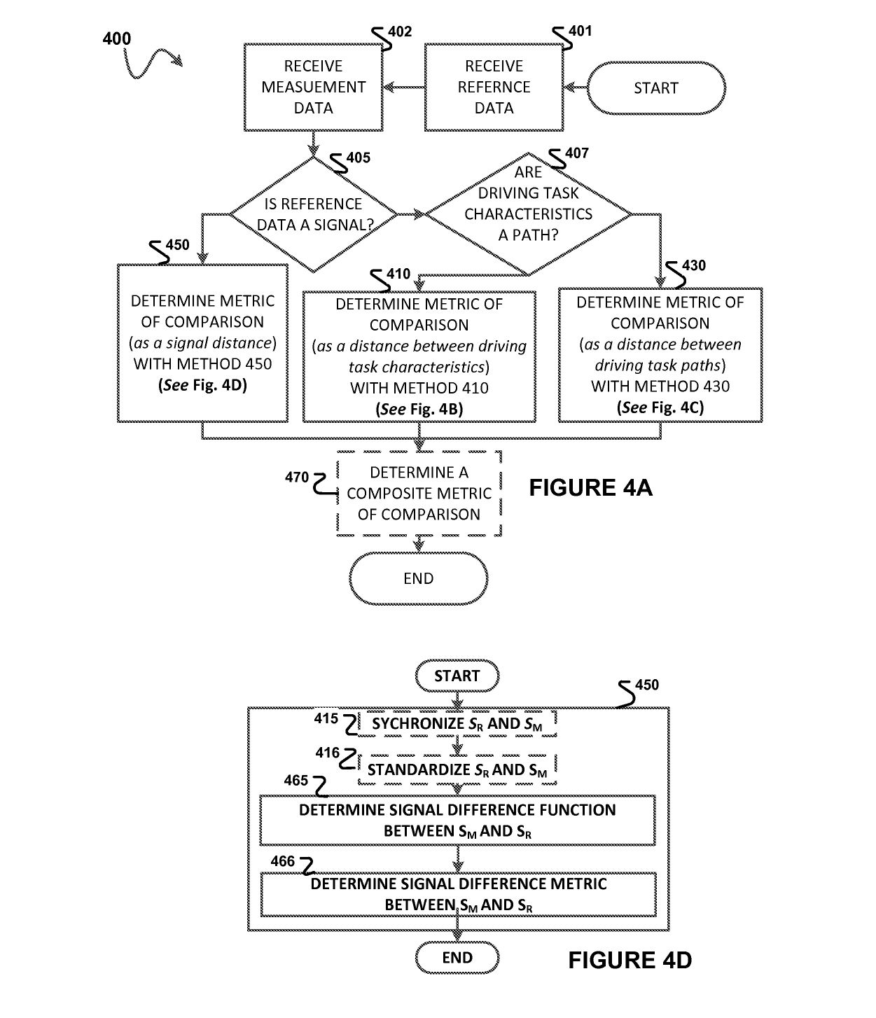

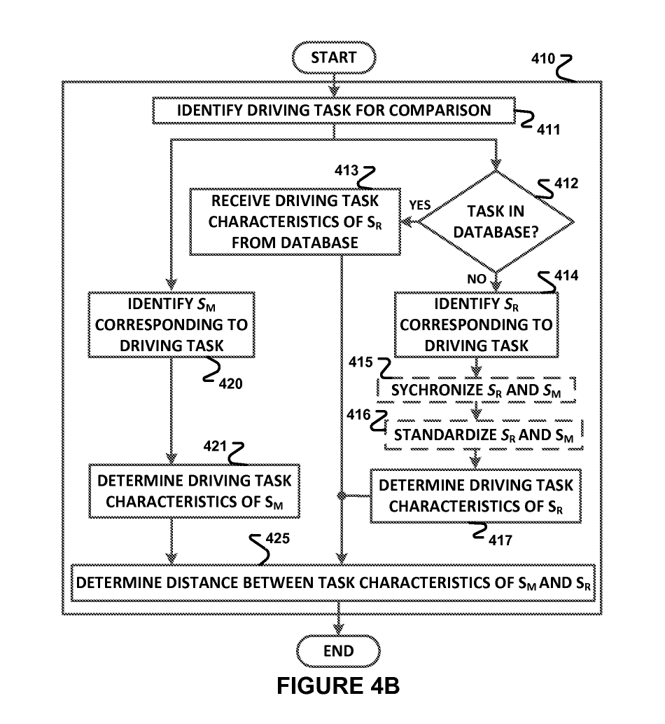

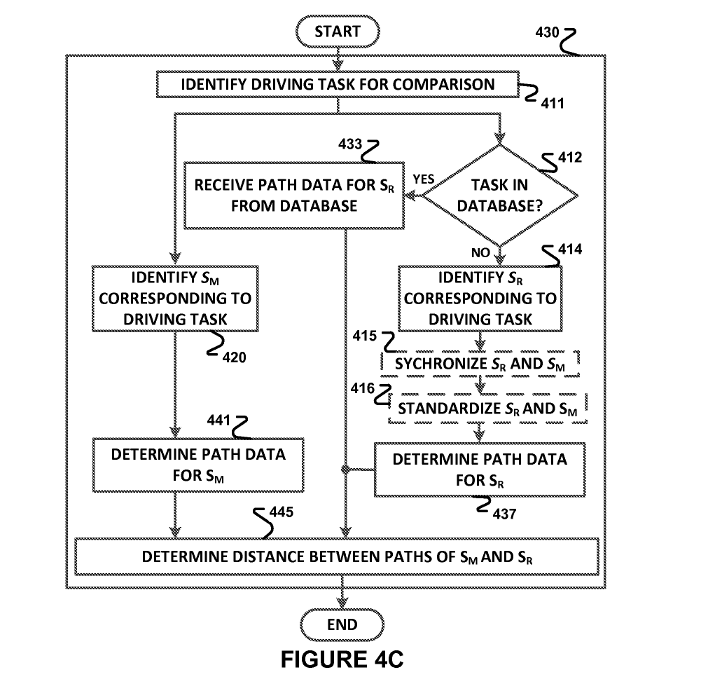

In another set of embodiments, measurements are taken of a large number of different human drivers (in known or unknown status) executing the same set of driving tasks. Measurements are taken of their performance and then combined in a statistically relevant fashion to form the reference signal. FIG. 5 provides an illustration of such an embodiment, in which a large number of drivers traverse a particular right-hand turn. Roadway graph 500 comprises a right-hand turn between two roadway boundaries 501a, 501b. Trajectories 510 of a large number of vehicles piloted by various drivers are marked on the roadgraph 500. A statistical average 520 (or, alternatively, another measure of statistical centrality, e.g., mean, etc.) of the trajectories 510 is calculated and illustrated. A standard deviation 530 (or, alternatively, another measure of statistical spread, e.g., variance, etc.) is also determined and illustrated. The average path 520 taken through the turn can then be used as a reference signal (composed of physical state parameters of position, and by inference, orientation of the vehicle.) Standard deviation 530 can also be used, in accordance with particular embodiments, as a threshold by which to determine meaningful deviations from average path 520 when conducting signal comparisons (discussed more fully below, in connection with the multiple views of FIG. 4). While the example of FIG. 5 centers on calculating average trajectories, any one or more physical or control state parameters could be used in the statistical analysis and then organized into a signal component.

An average path 520 representative of the set of all paths 510 taken by all the drivers can be computed by taking the set of vehicle location signals, {(x₁(t),y₁(t)), (x₂(t),y₂(t)) . . . (x_{N}(t),y_{N}(t))} where the signals have been synchronized such that at t=0, all the vehicle location signals are beginning the driving task of interest. The average trajectory is computed by finding the statistical average for position (x, y, z) for each time, thusly:

$$\overline{x} ( t ) = \frac{1}{N} {\sum }_{i}^{ } {x}_{i} ( t ) , \\ \overline{y} ( t ) = \frac{1}{N} {\sum }_{i}^{ } {y}_{i} ( t ) . \qquad ( 3 a ) , ( 3 b )$$

The standard deviation of the trajectory can likewise be computed:

$${σ}_{x} ( t ) = \sqrt{\frac{1}{N} {\sum }_{i}^{ } {( {x}_{i} ( t ) - \overline{x} ( t ) )}^{2}} , \\ {σ}_{y} ( t ) = \sqrt{\frac{1}{N} {\sum }_{i}^{ } {( {y}_{i} ( t ) - \overline{y} ( t ) )}^{2}} , \qquad ( 4 a ) , ( 4 b )$$

Other embodiments may synchronize the vehicle trajectories 510 from different drivers based on a function for warping such as a dynamic time warping and/or the like in order to best align the different trajectories taken. As such, according to one embodiment, the average trajectory and standard deviations may comprise:

$$\begin{matrix}\overline{x} ( t ) = \frac{1}{N} {\sum }_{i}^{ } {x}_{i} ( {f}_{i} ( t ) ) , \\ \overline{y} ( t ) = \frac{1}{N} {\sum }_{i}^{ } {y}_{i} ( {f}_{i} ( t ) ) & ( 5 a ) , ( 5 b ) \\ {σ}_{x} ( t ) = \sqrt{\frac{1}{N} {\sum }_{i}^{ } {( {x}_{i} ( {f}_{i} ( t ) ) - \overline{x} ( t ) )}^{2}} , \\ {σ}_{y} ( t ) = \sqrt{\frac{1}{N} {\sum }_{i}^{ } {( {y}_{i} ( {f}_{i} ( t ) ) - \overline{y} ( t ) )}^{2}} & ( 6 a ) , ( 6 b )\end{matrix}$$

For the measured set of paths, the distance (whether a Frechet distance, time-warping distance, and/or the like) between the path 510 and the average reference path 520 can be computed, and be used to compute the average and standard deviation of distance between the set of paths and the average reference path.

Other embodiments may use specific reference signals that are designed to accomplish one or more operational objectives, such as a reference signal that maximizes fuel consumption for a particular set of driving tasks, or a reference signal that minimizes collision risk during one or more driving tasks, or that minimizes trip time, and/or the like. Such signals may be constructed either by simulation through autonomous driving systems with specific characteristics programmed in (e.g., fuel consumption), or by direct physical and mathematical calculation. Particular embodiments may use population sampling, either with or without data filtering, for the specific operational objectives in mind. This could be accomplished, by way of non-limiting example taken from FIG. 5, by discarding those trajectories 510 in which it was determined that the vehicle consumed more than a specified amount of fuel or took more or less than a specified amount of time in traversing the turn.

Driving Tasks

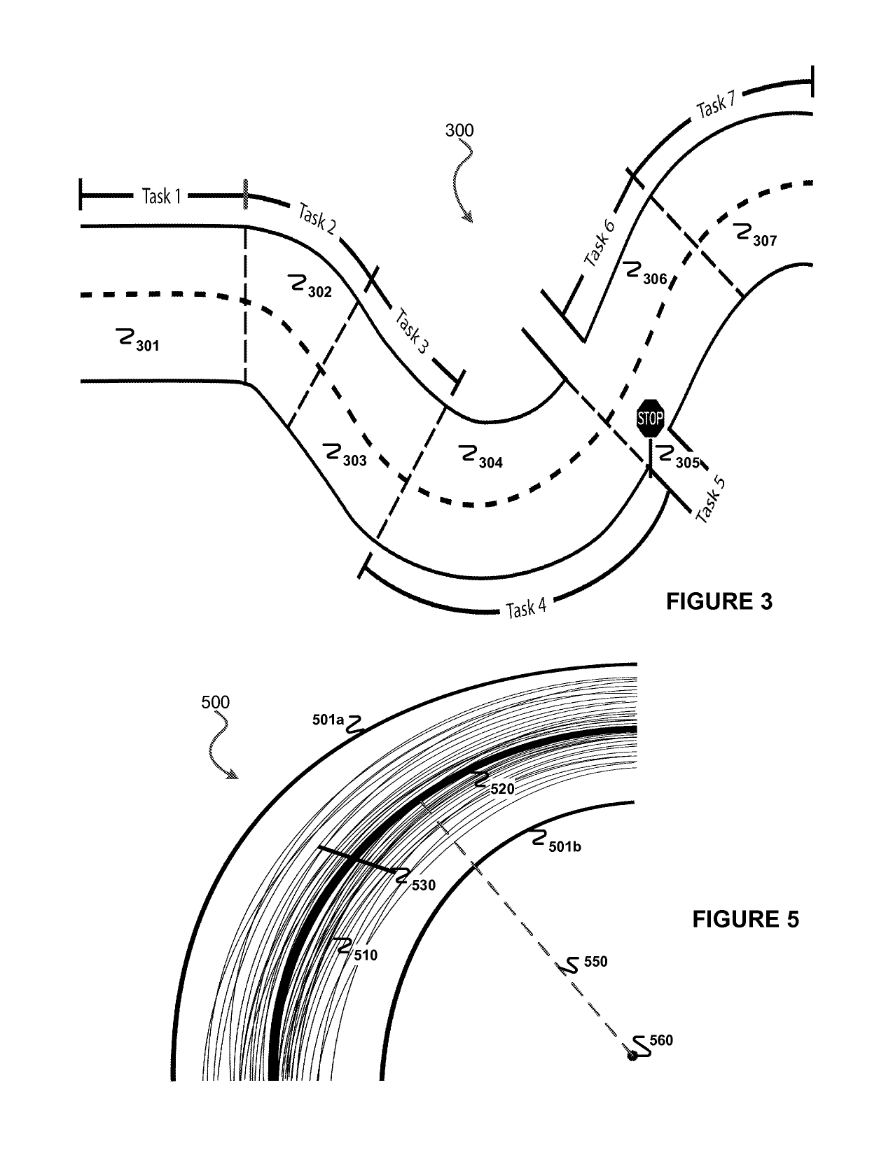

Particular embodiments of the presently disclosed invention consider a driving trip (i.e., the movement of a vehicle from one point to another by driving it) as a set of one or more discrete driving tasks for a given driver. FIG. 3 provides an illustration of this concept, in accordance with particular embodiments. According to particular embodiments, a driving task may be characterized at least in part by one or more roadway parameters, where a roadway parameter is indicative of a one or more physical characteristics of a road or other driving surface, including but not limited to: classification of lane shape (e.g. straightaway, curved), curvature radius of lane, speed limit, number of lanes, width of lanes, geographical location, and/or the like. According to particular embodiments, a driving task may additionally be characterized by one or more environmental parameters—such as, without limitation, an object in the roadway, a particular type of road surface, a particular traffic pattern, and/or the like. According to particular embodiments, a driving task may have a start and end time. According to particular embodiments, a driving task may additionally be characterized by one or more of a start location, an end location, and intermediate locations. By way of example a driving task may comprise a straight roadway without obstacles, or a curved roadway with one stationary obstacle, a straight roadway with gravel surface and light rain and/or the like. According to particular embodiments, a driving task may also be designed to isolate one or more driving performance metrics based upon one or more key vehicle state parameters that may be particularly indicative of driving performance in the given driving scenario. Non-limiting examples include a steering wheel deviation metric that focuses on steering wheel angle Ø, a lane deviation metric that focuses on a lane position L, the radius-of-curvature deviation metric that focuses on the radius of curvature analysis discussed in connection with the curve of FIG. 5, above, and/or the like.

For the non-limiting example of FIG. 3, the first, third, and sixth driving tasks 301, 303, 306 comprise straight sections of roadway. The second and seventh driving tasks 302, 307 comprise right-hand curves. The fourth driving task 304 comprises a left-hand curve, and the fifth driving task comprises executing a stop at an intersection. Each of these tasks 301-307 may be seen as “primitive” upon which a driving trip is based, wherein the boundary between such primitives occurs at any reasonably detectable point of interest for convenience of subsequent analysis.

Further distinctions within the concept of a “driving task” may be utilized according to particular embodiments. A “specific driving task,” for example, refers to a particular stretch of road, a particular intersection, a particular environment factor, and/or the like, at a particular geographic location. Examples of specific driving tasks include the infamous curves of California Route 17, including “Valley Surprise” and “Big Moody Curve,” which are precise sections of Route 17 that are so treacherous they have been given names by local residents. (A specific driving task need not be famous, however.) According to particular embodiments, specific driving tasks may be associated with a specific-driving-task identifier (e.g., the aforementioned names of infamous California Highway 17 curves, a serial number, a database identifier field, and/or the like). Conversely, a “driving task classification” refers to a particular category of roadways, intersections, and/or the like, that have one or more identifying traits in common. Table 3, for example, lists different driving task classifications. It also outlines the physical state parameters involved in the driving task, along with possible (non-limiting) approaches to measuring driver performance on such a driving task, and possible (non-limiting) techniques for comparing driver performance to a reference signal for such driving tasks.

Further, particular embodiments may make use of the concept of a driving task instance.

A “driving task instance” refers to a particular driver executing a driving task at a particular time—e.g., John Smith driving a left-handed curve on Sunday, May 5, between 8:45:43 AM and 8:47:06 AM. A driving task instance may also, according to particular embodiments, be further analyzed into a “specific driving task instance,” which refers to a specific driver executing a specific driving task at a given time—e.g., John smith driving Big Moody Curve (not just any left-handed curve) on Sunday, May 5, between 8:45:43 AM and 8:47:06 AM.

Furthermore, the presently disclosed invention may make use not only of processes that include aggregating one or more driving tasks into a driving trip, but also of processes that include analyzing a given driving trip into one or more driving tasks. As discussed in greater detail in connection with processes 410 and 430 of FIGS. 4B and 4C, respectively, such processes include analyzing measurement and/or reference signals into portions thereof that correspond to one or more driving tasks or one or more specific driving tasks (see, e.g., step 420 of methods 410 and 430). Furthermore, once a driving task and/or a specific driving task is identified as comprising, at least in part, a given driving trip, particular embodiments may also classify the identified driving task and/or the identified specific driving task according to its driving task classification. Yet other embodiments may further associate a specific-driving-task identifier with any such specific driving tasks so identified or may further associate a driving-task-classification identifier with any identified driving tasks that may be so classified.

TABLE 3
Exemplary Driving Task Classifications

| | DRIVING TASK | | | |
|---|---|---|---|---|
| CLASS | CLASSIFICATION | OBSERVABLES OF THE | DRIVER PERFORMANCE | MANNER OF COMPARING |
| No. | DESCRIPTION | DRIVER'S PERFORMANCE | MEASUREMENT | TO REFERENCE SIGNAL |
| 1. | Single Straightaway | Speed, acceleration, | Speedometer (Speed, | Deviation from a |
| | | path straightness | acceleration), Assisted GPS | constant speed and a |
| | | | (path straightness), steering | straight trajectory. |
| | | | wheel (measures deviation | |
| | | | from straight path), radar | |
| | | | gun | |
| 2. | Straightaway w/ | No. 1 (above) plus | No. 1 (above) plus | High response time, |
| | fixed obstacle | nearest distance to | Speedometer (breaking | low breaking duration, |
| | | obstacle (0 = collision), | duration and force), | aggressive |
| | | breaking force, breaking | Response time from | acceleration/deceleration |
| | | duration, Steering wheel | appearance of obstacle | (second time |
| | | motion, time elapsed | (where appearance is | derivative of velocity), |
| | | between appearance of | measured independently), | high θ′ and θ″, |
| | | obstacle and application | assisted GPS (nearest | deviation from control |
| | | of break | distance to obstacle) angle | speed (which may |
| | | | of rotation θ of steering | vary near the |
| | | | wheel and its first, θ′, and | obstacle), low nearest |
| | | | second, θ″, time derivatives. | distance to the |
| | | | | obstacle. |
| 3. | Straightaway with | No 1 (above) plus | No. 2 (above) plus, assisted | Aggressive |
| | another vehicle | nearest distance to | GPS (nearest distance to | acceleration/deceleration |
| | moving in a fixed | vehicle (0 = collision), | other vehicle/s) | (second time |
| | direction at fixed | breaking force, breaking | | derivative of velocity), |
| | speed | duration, steering wheel | | high θ′ and θ″, |
| | | motion, time elapsed | | deviation from control |
| | | between appearance of | | speed (which may |
| | | vehicle and application | | vary near other |
| | | of breaks | | vehicles), low nearest |
| | | | | distance to the |
| | | | | obstacle. |
| 4. | Straightway with | No. 3 (above) plus | No. 3 (above) plus assisted | No. 3 (above) |
| | another vehicle | whether adequate | GPS (maneuvers executed) | |
| | moving in a slightly | breaking and/or | | |
| | unpredictable | avoidance maneuvers | | |
| | pattern | were executed | | |
| 5. | Straightaway with | No. 4 (above) plus | No. 4 (above) | No. 3 (above) |
| | another vehicle | whether strong breaking | | |
| | moving in a highly | and/or significant | | |
| | unpredictable | avoidance maneuvers | | |
| | pattern | were executed | | |
| 6. | Straightaway with 2 | No. 3 (above) plus | No. 4 (above) | No. 3 (above) |
| | or more vehicles | nearest distance | | |
| | moving in a fixed | measurements taken for | | |
| | direction | all other vehicles | | |
| 7. | Straightaway with 2 | No. 4 (above) plus | No. 4 (above) | No. 3 (above) |
| | or more vehicles | nearest distance | | |
| | moving in a slightly | measurements taken for | | |
| | unpredictable | all other vehicles | | |
| | pattern | | | |
| 8. | Straightaway with 2 | No. 5 (above) plus | No. 4 (above) | No. 3 (above) |
| | or more vehicles | nearest distance taken | | |
| | moving in a highly | for all other vehicles | | |
| | unpredictable | | | |
| | pattern | | | |
| 9. | Curve (constant | Speed, acceleration, | Speedometer (Speed, | Deviation from a |
| | radius of curvature, | Constancy of radius of | acceleration), assisted GPS | constant radius, |
| | R) | curvature | (constancy of radius), angle | aggressive |
| | | | rotation of steering wheel | acceleration/deceleration |
| | | | and its first, θ′, and second, | (second time |
| | | | θ″, time derivatives. | derivative of velocity) |
| | | | | and high θ′ and θ″. |
| 10. | Curve (constant R) | No. 9 (above) plus | Speedometer (Speed, | Aggressive |
| | with a fixed | nearest distance to | acceleration), assisted GPS | acceleration/deceleration |
| | obstacle | obstacle (0 = collision), | (constancy of radius, nearest | (second time |
| | | breaking force, breaking | distance to other vehicle/s), | derivative of velocity), |
| | | duration, Steering wheel | angle rotation of steering | high θ′ and θ″, |
| | | motion, time elapsed | wheel and its first, θ′, and | deviation from control |
| | | between appearance of | second, θ″, time derivatives. | speed (which may |
| | | obstacle and application | | vary near the |
| | | of break | | obstacle), low nearest |
| | | | | distance to the |
| | | | | obstacle. |
| 11. | Curve (constant R) | No. 10 (above) | Speedometer (Speed, | No. 10 (above) |
| | with another | | acceleration), assisted GPS | |
| | vehicle moving in a | | (constancy of radius), angle | |
| | fixed curvature of R′ | | rotation of steering wheel | |
| | (R′ possibly = R) at a | | and its first, θ′, and second, | |
| | fixed speed | | θ″, time derivatives. | |
| 12. | Curve with another | No. 10 (above) plus | Speedometer (Speed, | No. 10 (above) |
| | vehicle moving in a | whether adequate | acceleration), assisted GPS | |
| | slightly | breaking and/or | (maneuvers executed, | |
| | unpredictable | avoidance maneuvers | constancy of radius), angle | |
| | pattern | were executed | rotation of steering wheel | |
| | | | and its first, θ′, and second, | |
| | | | θ″, time derivatives. | |
| 13. | Curve with another | No. 10 (above) plus | Speedometer (Speed, | No. 10 (above) |
| | vehicle moving in a | whether strong breaking | acceleration), assisted GPS | |
| | highly | and/or avoidance | (maneuvers executed, | |
| | unpredictable | maneuvers were | constancy of radius), angle | |
| | pattern | executed | rotation of steering wheel | |
| | | | and its first, θ′, and second, | |
| | | | θ″, time derivatives. | |
| 14. | Curve with 2 or | No. 13 plus No. 6 | No. 13 (above) | No. 10 (above) |
| | more vehicles | | | |
| | moving in a fixed | | | |
| | direction | | | |
| 15. | Curve with 2 or | No. 14 plus No. 7 | No. 13 (above) | No. 10 (above) |
| | more vehicles | | | |
| | moving in a slightly | | | |
| | unpredictable | | | |
| | pattern | | | |
| 16. | Curve with 2 or | No. 15 plus No. 8 | No. 13 (above) | No. 10 (above) |
| | more vehicles | | | |
| | moving in a highly | | | |
| | unpredictable | | | |
| | pattern | | | |

Driving Task Characteristics

Performance standards and actual driving performance on a driving task may be quantified in a fashion that permits a standardized expression that encodes the relevant information in an optimized way and allows for extraction of the relevant difference between the recorded the measurement and reference signal time series in a data optimized way. As one-non limiting example, a signal indicating how to execute the driving task illustrated in FIG. 5 may be reduced to a single value in the form of a radius of curvature 550, understood to be a distance from an arbitrary fixed central point 560. This radius 550 may then be considered a characteristic of the driving task comprising right-hand curve 500. As with other driving characteristics, the reference data comprising a radius of curvature for curve 500 may be determined through measuring a large population of drivers executing curve 500 (as discussed previously), by observing (through its internal operations and data) the performance of an autonomous driving system execute curve 500, or through direct or indirect measurement and analysis of the geometry and topology of curve 500 itself (e.g., geographic surveys, road map analysis, satellite pictures, etc.). Other driving tasks can be reduced to one or more driving task characteristics such as, without limitation: length of straightaway, arc length of curvature, average duration to complete driving task, straightness of path through driving task, and/or the like. Depending upon how the driving task measurement is conducted, when used as a reference signal, a tolerance may also be included, such as a standard deviation or a variance in the population data used to determine the driving task characteristic.

Driving Task Path Determination

A particular driving task characteristic, namely the driving task path—understood to be the actual path taken (or to be taken according to a standard of performance) through a driving task—is of such significant importance and deserves special treatment because of its important role in particular embodiments. The actual path taken through a driving task—understood as a set of position coordinates describing the vehicle's position as the driver maneuvers through the driving task—may not be immediately available for comparison or other data analysis, however, depending upon the parameters involved in measuring the vehicle state. If position \vec{X} 102 is one of the parameters included as a component of a measurement or reference signal, determining a driving task path may be fairly straightforward and in accordance with techniques well known in the art (e.g., elimination of the parametric time variable, etc.). When position \vec{X} 102 is not one of the parameters included as a signal component, various techniques and formulas may need to be applied to the signal to generate the path. In particular embodiments, the signal is reduced to a time series representing the positions over time in a two-dimensional plane or in a three-dimensional space and then reduced to a driving task path. In other embodiments, one or more other techniques are used, such as (without limitation), dead reckoning, integrating velocity and acceleration parameters over time (with or without initial or boundary conditions), integrating the orientation or steering wheel angle parameters over time (also with or without initial or boundary conditions), and/or the like.

Comparing Measurement and Reference Signals

Driver performance is analyzed in particular embodiments by comparing measurement data to reference data and determining a metric of comparison. Different techniques for comparing the measurement data and the reference data are used, according to different embodiments, based largely (though not exclusively) on the format in which the reference data is received. If the reference data is in the form of a reference signal, method 450 of FIG. 4D may be employed, in which case the metric of comparison is a signal distance. If the reference data is in the form of driving task characteristics, method 410 of FIG. 4B may be employed, in which case the metric of comparison is a distance between driving task characteristics. Further, if the reference data is in the form of a driving task path, method 430 of FIG. 4C may be employed, in which case the metric of comparison is a distance between driving task paths.

FIG. 4A encapsulates this logic in method 400, which commences in step 401 in which the reference data is received. Step-401 received reference data may comprise any data useful for expressing a standard of driving performance. In particular embodiments, step-401 received reference data may comprise: a reference signal \vec{S}_{R}(t) (such as, without limitation, any signal identified in Tables 2A and 2B or their equivalents), one or more reference driving task characteristics, one or more reference driving task paths and/or the like. Method 400 continues in step 402, in which measurement data is received. In particular embodiments, step-402 received measurement data may comprise: a measurement signal \vec{S}_{M}(t) (such as, without limitation, any signal identified in Tables 2A and 2B or their equivalents), one or more measurement driving task characteristics, one or more measurement driving task paths and/or the like. Steps 401 and 402 may be occur in any order, may occur simultaneously, may occur repeatedly, or may occur continuously, and/or in any fashion suitable or necessary to conduct a comparison with methods 410, 430, and 450 or their equivalents.

Comparison methods 410, 430, 450 are then selected in method 400 by proceeding to question blocks 405, which asks whether the step-401 received reference data is a reference signal \vec{S}_{R}(t), and if so then proceeds to block 450 where method 450 (discussed below in connection with FIG. 4D) determines a metric of comparison between the measurement and reference signals in the form of a signal distance.

If the step-401 received is not a reference signal, it is then assumed that the step-401 received reference data comprises one or more driving task characteristics. Method 400 then proceeds to question block 407, which asks whether the step-401 reference data also comprises one or more driving task paths. If not, method 400 proceeds to step 410 where method 410 (discussed below in connection with FIG. 4B) determines a metric of comparison between the step-401 received reference data in the form of driving task characteristics and the step-402 received measurement data in the form of measurement signal \vec{S}_{M}(t). If the step-401 received reference data (assumed to be one or more driving task characteristics) is also one or more driving task paths, method 400 then proceeds to step 430 where method 430 (discussed below in connection with FIG. 4C) determines a metric of comparison in the form of a driving task path distance.

Comparison of Driving-Task Characteristics

FIG. 4B provides a flowchart illustrating a method 410 for determining a metric of comparison utilizing a comparison of driving-task characteristics, in accordance with particular embodiments. Method 410 commences in step 411, wherein a driving task T_{DR} is identified. A step-411 driving task T_{DR} may comprise any variety of driving task expounded within the foregoing discussion (see, e.g., FIG. 3), including but not limited to a specific driving task, a driving task instance, a specific driving task instance, a driving task classification, and/or the like. If the step-411 identified driving task T_{DR} is a specific driving task or a driving task classification, step 411 may carry out the identification process based at least in part on a specific-driving-task identifier and/or a driving-task-classification identifier.

Method 410 continues in a branch comprising the next steps of steps 412 and 420, which may occur simultaneously, continuously, or in any order. The step-412 branch, addressed here first, commences in step 412, which queries whether the step-411 driving-task characteristic data for received driving task T_{DR} is contained in a database. If so, characteristics of driving-task T_{DR} are then retrieved from the database in step 413, before a comparison metric is determined in step 425 (discussed below). The step-413 received driving task characteristics may take different forms, according to particular embodiments, depending upon the type of driving task T_{DR} identified in step 411. If the step-411 driving task T_{DR} is a specific driving task, the step-413 received driving task characteristics may be of a precise nature, specifying the population average and deviation for performing a specific driving task. Conversely, according to other embodiments, if the step-411 identified driving task T_{DR} is a driving task classification (such as a curve of known radius), the step-413 received driving task characteristic may be of a less precise nature (such as, without limitation, an approximate radius of curvature and an estimated standard of deviation from that radius of curvature for the general population)—having been determined by approximation using basic principles of how a standard of performance should be constructed for such driving task classifications, instead of having been measured from actual people navigating a specific driving task.

Otherwise, if the step-412 database query fails, flow proceeds to step 414, in which the optional step-401 reference data, comprising reference signal \vec{S}_{R}(t), is analyzed to determine and locate that signal segment comprising the data referencing the standard of performance corresponding to the step-411 received driving task T_{DR}. Method 410 then proceeds to optional step 415 in which the step-401 received reference data, comprising reference signal \vec{S}_{R}(t) and the step-402 received measurement data, comprising measurement signal \vec{S}_{M}(t), are synchronized for proper comparison. Optional step-415 synchronization may take any form as is known in the art, including but not limited to time-stamp synchronization with or without an offset, synchronizing image or video data with respect to key landmarks, synchronizing location data with respect to fixed reference points, and/or the like. Optional step-415 synchronization may comprise any technique whereby a comparison between data sets from the step-401 receive reference signal \vec{S}_{R}(t) and the step-402 receive measurement signal \vec{S}_{M}(t) may be correlated for proper comparison as relating to the same physical space and/or event timing of the driving task received in step 411.

Subsequent optional step 416 then standardizes the data from step-401 received reference signal \vec{S}_{R}(t) and step-402 received measurement signal \vec{S}_{M}(t). Optional step-416 standardization is designed to ensure that the reference and measurement signals contain the same components, expressed in the same units, and otherwise permit logical mathematical processing in an appropriate and meaningful standardized way. Optional step-416 standardization may comprise, without limitation: conversion of units (e.g., distances expressed in kilometers converted to distances expressed in miles, and/or the like); conversion of one or more vehicle control state parameters into one or more vehicle physical state parameters or vice versa (e.g., converting accelerator and brake data to velocity and acceleration data, converting vehicle orientation to steering wheel orientation, and/or the like); conversion between different physical states; conversion between different control states; conversion from one form of a vehicle state parameter into another comparable form to account for differences in measurement systems used (e.g., steering wheel angle as measured from a steering wheel sensor into steering wheel angle as measured from a vehicle wheel sensor, etc.) and/or the like. Techniques for optional step-416 standardization are well known in the art and have been alluded to throughout the foregoing discussion. In particular embodiments, the step-401 received reference data is standardized to the step-403 received measurement data, whereas in other embodiments the step-403 received measurement data is standardized to the step-401 received measurement data, and in yet other embodiments both the step-401 received reference data and the step-403 received measurement data are standardized to one or more standardized data forms (e.g., standardized signal components expressed in standardized units as measured from standard sensors, etc.).

Method 410 then proceeds to step 417 wherein driving task characteristics corresponding to the step-411 received driving task T_{DR} are then determined from the now synchronized and standardized portion of the step-401 received reference signal S_{R}(t) corresponding to the step-411 identified driving task T_{DR}. Step-417 determination of driving-task characteristics of the reference signal correspond to driving task T_{DR} may occur in any method as described in the foregoing discussion. The step-412 branch of method 410 is then complete.

In the step-420 branch of method 410, step 420 proceeds by identifying that portion of the step 402-received measurement signal \vec{S}_{M}(t) that corresponds to the step-411 identified driving task T_{DR}. Synchronization and standardization of the step-420 identified portion of the measurement signal \vec{S}_{M}(t) (not shown) may also take place in accordance with those techniques discussed in connection with optional steps 415 and 416 with respect to the reference signal \vec{S}_{R}(t).

Method 410 then proceeds to step 421 wherein one or more driving-task characteristics are determined for the step-420 identified portion of the step-402 received measurement signal \vec{S}_{M}(t) corresponding to the step-411 identified driving task. Step-421 determination of driving-task characteristics of the measurement signal corresponding to driving task T_{DR} may occur in any method as described in the foregoing discussion. The step-420 branch of method 410 is then complete.

Method 410 then proceeds to step 425 in which driving task characteristics from the measurement signal are compared to driving-task characteristics from the reference signal. Measurement-signal driving task characteristics are received from foregoing step 421, but reference-signal driving-task characteristics may be received from either step 413 or step 417, depending upon results of the step-412 query. Step 425 accomplishes the signal comparison by determining a mathematical distance between the two sets of driving-task characteristics. The step-425 determined driving task characteristic distance may comprise any distance or distance-related metric as are well known in the art including but not limited to a linear distance (e.g., a simple difference or true value of a difference), a Euclidean distance (i.e., distance in N-dimensional space), a weighted Euclidean distance (where the weight of each dimension is determined by operational objectives, discussed more fully below), an epsilon insensitive distance, and/or the like. The step-435 determined distance between driving task parameters then comprises the step-403 determined metric of comparison. Method 410 is then complete. According to particular embodiments, however, method 410 may run continuously, in series with other comparison methods 430, 450, etc., and/or may be run continuously for a period of time.

In particular embodiments the reference driving task parameters include both a mean reference task parameter and a measure of dispersion (such as a standard deviation of the reference task parameter, its variance, and/or the like) in which case the metric of comparison can be a normalized distance. The normalized distance may comprise the difference between a mean reference driving task characteristic and the measured driving task characteristic, divided by the standard deviation of the reference task characteristic. Likewise, the reference task characteristic can include a mean and tolerance reference component, ε, in which an epsilon-insensitive distance can be used, where differences between the mean reference parameter and the measured reference parameter less than some tolerance, ε, is assigned a distance of zero, otherwise the distance is the absolute difference between the mean reference parameter and the measured driving task characteristic, and subtract the tolerance, ε.

According to particular embodiments, it may be possible to determine a step-425 driving task characteristic distance dedicated to particular driving task characteristics of interest. By way of non-limiting example, a meaningful step-425 driving task characteristic distance may be determined using only one of any of the following parameters: radius of curvature for “curve” variety driving task (a so-called “radius-of-curvature-deviation metric”), elapsed time to execute the driving task (a so-called “elapsed-time metric), and/or the like

Comparison of Driving-Task Paths

FIG. 4C provides a flowchart illustrating an alternative method 430 for conducting a step-403 signal comparison of method 400 utilizing a path comparison for particular driving tasks, in accordance with particular embodiments. Method 430 shares steps 411-412, 414-416, and 420 in common with method 400 of FIG. 4B. Method 430, however, uses driving-task paths as derived from path data as the basis of comparison instead of driving-task characteristics. As such, in step 433, path data corresponding to driving task T_{DR} is received from the database instead of driving-task characteristics. Steps 437 and 441 similarly determine path data from the identified (and optionally standardized and/or synchronized) step-401 reference data or reference signal and the step-402 measurement signal, respectively. Path data is determined from any of the identified techniques from the foregoing discussion.

Method 430 then proceeds to step 445 wherein a distance between paths is determined. Step-445 determined distance may be a Frechet distance, a time-warping distance, a least-common subsequence distance, and/or the like. In particular embodiments the reference driving task path includes the a reference path, an average distance from the reference path, and a measure of dispersion relative to the distance to from the reference path, such as the standard deviation of the distance to the reference path. In this case the metric can be defined as the distance (such as a Frechet distance, time-warping distance, and/or the like) between the reference path and the measured path, subtracted by the average distance from the reference path, all divided by the norm both a mean reference task parameter and measure of dispersion, such as a standard deviation of the reference task parameter, in which case the metric of comparison can be a normalized distance, where the difference between mean reference task parameter and the measured task parameter is divided by standard deviation of the reference task parameter. Likewise, the reference task parameter can include a mean and tolerance reference parameter, ε, in which an epsilon-insensitive distance can be used, where differences between the mean reference parameter and the measured reference parameter less than some tolerance, ε, is assigned a distance of zero, otherwise the distance is the absolute difference between the mean reference parameter and the measured task parameter, but with the tolerance, ε, subtracted.

Continuous Comparison of Signals

FIG. 4D provides a flowchart illustrating an alternative method 450 for conducting a step-403 signal comparison of method 400 utilizing continuous signal comparison, in accordance with particular embodiments. Method 450 commences by assuring synchronization and standardization of the step-401 received reference signal \vec{S}_{R}(t) and the step-402 received measurement signal \vec{S}_{M}(t), per the techniques of optional steps 415, 416 (as discussed in connection with method 410 of FIG. 4B), respectively.

With synchronized and standardized signals, method 450 then proceeds in step 465, in which a signal distance function is determined for at least a portion of the reference signal \vec{S}_{R}(t) and corresponding portion of the measurement signal \vec{S}_{M}(t). A step-465 determined signal difference function Δ\vec{S}(t) expresses the difference between the respective functions in any of a number of ways, according to particular embodiments.

According one set of embodiments, a step-456 determined signal difference function Δ\vec{S}(t) comprises a simple difference between each corresponding component of the signal in the form of basic vector subtraction. It and its true value (also used as a step-456 determined signal difference function, according to particular embodiments), may be formed thusly:

Δ\vec{S}(t)=\vec{S}_{R}(t)−\vec{S}_{M}(t) (7)

Method 450 then proceeds to step 466 wherein a signal distance metric M_{Dist} is determined from the step-465 determined signal difference function Δ\vec{S}(t). A step-466 determined signal distance metric M_{Dist} may be any meaningful metric that can be formed from a step-465 determined signal difference function Δ\vec{S}(t). According to particular embodiments, the step-466 determined signal difference metric M_{Dist} is simply the Euclidean norm of a step-465 determined signal difference function Δ\vec{S}(t) over a given range of the signal. According to such embodiments, the step-466 determined signal difference metric M_{Dist} may be formed thusly:

M_{Dist}=∥\vec{S}(t)∥=∥\vec{S}_{R}(t)−\vec{S}_{M}(t)∥={square root over (Σⱼ₌₀^{N}(S_{R,j}(t)−S_{M,j}(t))²)} (7)

The step-466 determined signal difference metric M_{Dist} can be a weighted Euclidean norm, where the differences in each component of the signal are weighted independently. The weights may be different for different driving tasks, and may reflect the tolerances associated with variations within a particular component. As such, in accordance with other particular embodiments, the

M_{Dist}={square root over (Σⱼ₌₀^{N}α(j)(S_{R,j}(t)−S_{M,j}(t))²)} (8)

According to particular embodiments, the step-466 determined signal difference metric M_{Dist} may be determined for only a portion of a driving trip corresponding to only a portion of the reference and measurement signals \vec{S}S_{R}(t), \vec{S}_{M}(t). The portion in question may be determined by interval time points t₁ and t₂, and in other embodiments, they are positions X₁ and X₂. As such, the step-466 determined signal difference metric M_{Dist} may, according to other embodiments, be composed thusly:

M_{Dist}=∥Δ\vec{S}(t)∥|ₜ_{₁}^{t}_{²}Σ_{t:[t}_{₁}_{,t}_{₂}_{]}{square root over (Σⱼ₌₀^{N}(S_{R,j}(t)−S_{M,j}(t))²)} (9)

Additional techniques and formulations may be used for composing a step-466 determined signal difference metric M_{Dist}, according to additional embodiments, as are known in the art. Such techniques include, without limitation, mean-absolute distance, epsilon-insensitive distances, and/or the like. In particular embodiments the \vec{S}_{R}(t) includes a mean reference signal component and a measure-of-dispersion component (such as a standard deviation of the reference signal \vec{S}_{R}(t)), in which case the step-466 metric of comparison can be a normalized distance, where the difference between mean reference signal \vec{S}_{R}(t) and the measurement signal \vec{S}_{M}(t) is divided by a standard deviation of the reference signal, σ_{R} (t), on a component-by-component basis, such as:

$${M}_{Dist} = \sqrt{{\sum }_{j = 0}^{N} {( \frac{{S}_{R , j} ( t ) - {S}_{M , j} ( t )}{{σ}_{R , j} ( t )} )}^{2}} \qquad ( 10 )$$

According to yet other embodiments, the step-466 determined signal difference metric M_{Dist} may also comprise normalized Euclidean distance that can include different weights for each parameter (analogously to Equation 9, above) and/or be defined over specific intervals (analogously to Equation 10, above).

According to particular embodiments, the reference driving-task path can include a mean and tolerance reference parameter, ε, in which case an epsilon-insensitive distance can be used, where differences between the mean reference driving task path and the calculated reference driving task path less than some tolerance, ε, is assigned a distance of zero, otherwise the distance is the absolute difference between the mean reference driving task path and the calculated driving task path, but with the tolerance, ε, subtracted.

Composite Metrics of Comparison

Returning to FIG. 4A, once one or more individual metrics of comparison have been determined in accordance with one or more iterations of methods 410, 430, and/or 450 applied to one or more driving trips, one or more portions of a driving trip, and/or one or more driving tasks, it is possible to create a composite metric of comparison, according to particular embodiments, in optional step 470 of method 400 The composite metric M_{C} combines one or more metrics of comparison as determined by methods 410, 430, 450. According to particular embodiments, the composite metrics M_{C} of step 470 is determined by calculation, without limitation, one or more of: a simple average, a weighted average (where different previously determined metrics of comparison are weighted differently, based on importance, difficulty, or other operational objectives), a non-linear weighted average (where all the metrics are first transformed by a non-linear function, such as a logistic function, before performing a weighted average), a weighted average followed by a non-linear function (as in logistic regression), and/or the like.

According to particular embodiments, it may be possible to determine a step-466 signal distance metric dedicated to particular vehicle state parameters of interest. By way of non-limiting example, a meaningful step-466 signal-distance metric may be determined using only one of any of the following parameters: steering wheel angle (a so-called “steering wheel deviation metric), lane position (a so-called “lane-tracking metric), and/or the like.

System Embodiments

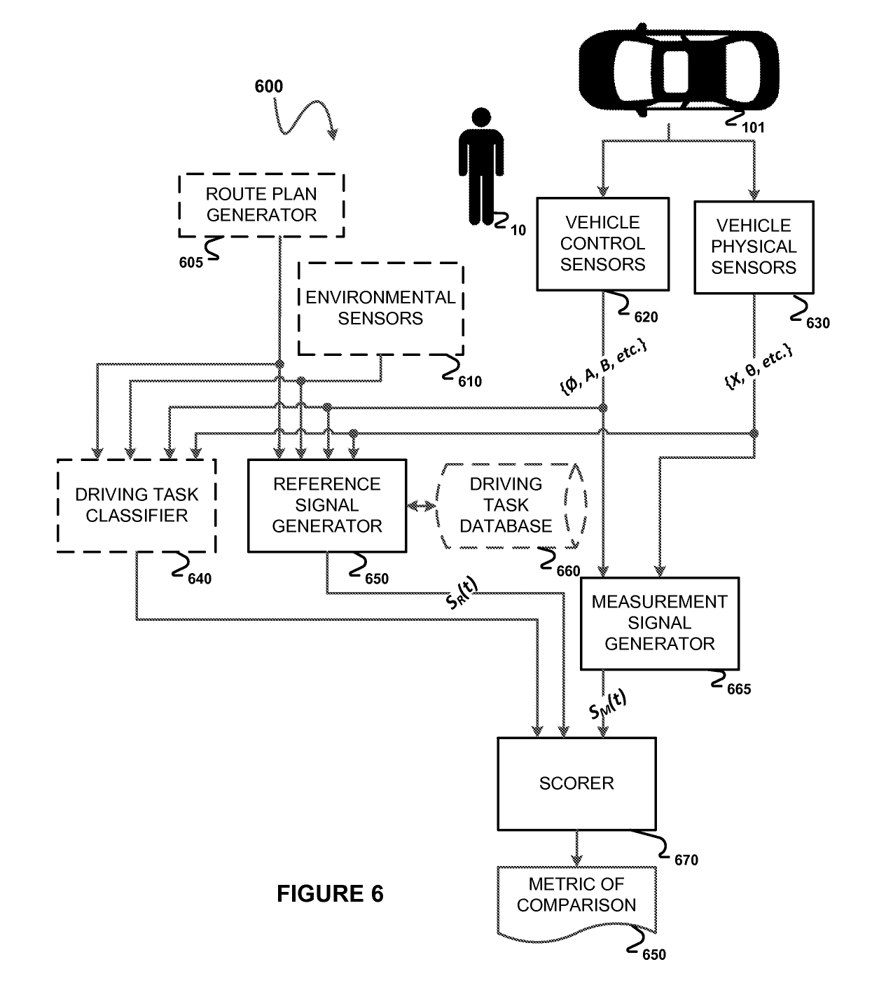

FIG. 6 provides a component-level block diagram of an exemplary and non-limiting system 600 for carrying out the methods of the presently disclosed invention, including but not limited to methods 400, 410, 430, and 450, according to particular embodiments. Vehicle 101 and driver 10 are shown, and are as discussed throughout the foregoing discussion. System 600 also contains an optional route plan generator 605 for generating route information useful for routes, from which driving tasks and reference signals may be identified. Route plan generator may be any technology capable of generating a route for a driving trip, including, without limitation, GPS systems with navigation aids, route planning software and/or website (Google™ Maps, Mapquest™, etc.), and/or the like. System 600 also contains sensor arrays 610, 620, and 630 comprising one or more environmental sensors, vehicle control state sensors, and vehicle physical state sensors, respectively, as discussed in the foregoing discussion.

Reference signal generator 650 is also included within system 600 and comprises any device or system capable of generating a reference signal, such as a step-401 received reference signal \vec{S}_{R}(t), as identified in the foregoing discussion. Optional driving task classifier 640 and driving task database 660 collectively, also part of system 600, also assist the reference signal generator 650 identify and classify driving tasks so as to perform the methods disclosed herein. Driving task classifier assists in determining the physical features of a driving task that may be reducible to a driving task characteristic for later comparison by scorer 670. Driving task database 660 contains data regarding specific driving tasks, such as location data, reference signal data, driving task characteristic data, driving task path data, specific-driving-task identifiers, driving-path-classification identifiers, and/or the like.

System 600 also contains scorer 670, which performs the signal comparison methods and scoring techniques discussed in the foregoing discussion, including without limitation methods 400, 410, 430, and 450. The output of scorer 670 is a driver performance metric 650. Driver performance metric may comprise any of the outputs of steps 403, 425, 445, and 466, in accordance with particular embodiments.

Fields of Application

The presently disclosed invention finds applications in a wide range of fields of endeavor. Once a driver performance metric is determined for a particular driver on a given driving trip, a large number of additional inferences may be drawn therefrom. These include, without limitation, collision risk, fuel efficiency, neurobehavioral status (e.g., fatigue state, alertness level), and/or the like all of which may be of interest in operations personnel in the transportation, healthcare, insurance, mechanical and civil engineering, and medical fields.

### Additional Embodiments

Certain implementations of the invention comprise computers and/or computer processors which execute software instructions which cause the processors to perform a method of the invention. For example, one or more processors in a system may implement data processing blocks in the methods described herein by executing software instructions retrieved from a program memory accessible to the processors. The invention may also be provided in the form of a program product. The program product may comprise any non-transitory medium which carries a set of computer-readable instructions that, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. Such a system may enable a distributed team of operational planners and monitored individuals to utilize the information provided by the invention. A networked system may also allow individuals to utilize a graphical interface, printer, or other display device to receive personal alertness predictions and/or recommended future inputs through a remote computational device. Such a system would advantageously minimize the need for local computational devices.

Certain implementations of the invention may comprise exclusive access to the information by the individual subjects. Other implementations may comprise shared information between the subject's employer, commander, medical professional, insurance professional, scheduler, or other supervisor or associate, by government, industry, private organization, and/or the like, or by any other individual given permitted access.

Certain implementations of the invention may comprise the disclosed systems and methods incorporated as part of a larger system to support rostering, monitoring, selecting or otherwise influencing individuals and/or their environments. Information may be transmitted to human users or to other computerized systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components that are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method, using a computer, for assessing driver performance relative to a standard of performance, the method comprising:
receiving measurement data at a computer, the measurement data indicative of one or more vehicle state parameters corresponding to a driver operating the vehicle during a driving trip;
receiving reference data at the computer, the reference data indicative of one or more vehicle state parameters corresponding to a standard of performance for the vehicle during at least a portion of the driving trip; and
determining, at the computer, at least one metric of comparison based at least in part on the received measurement data and the received reference data, the metric of comparison indicative of an assessment of the driver operating the vehicle relative to the standard of performance for at least a portion of the driving trip.

2. A method according to claim 1 wherein receiving the measurement data at a computer comprises receiving a measurement signal at a computer, the measurement signal being comprised of one or more time series functions of vehicle state parameters corresponding to a driver operating a vehicle during a driving trip.

3. A method according to claim 1 wherein receiving the measurement data comprises receiving one or more measurement driving task characteristics at the computer, the one or more measurement driving task characteristics each being indicative of one or more vehicle state parameters during execution of a driving task by the driver.

4. A method according to claim 1 wherein receiving reference data at the computer comprises receiving a reference signal at the computer, the reference signal being comprised of one or more time series functions of vehicle state parameters representing the standard of performance for the vehicle during at least a portion of the driving trip.

5. A method according to claim 1 wherein receiving reference data at the computer comprises receiving one or more reference driving task characteristics at the computer, the one or more reference driving task characteristics each being indicative of one or more vehicle state parameters during execution of a driving task in conformity with the standard of performance for the driving task.

6. A method according to claim 1 wherein the determined at least one metric of comparison is determined for the entire trip.

7. A method according to claim 1 wherein the driving trip is comprised of at least one driving task, wherein the received reference data comprises reference data relating to the at least one driving task, and wherein the determined at least one metric of comparison is determined for the at least one driving task.

8. A method according to claim 1 wherein at least one the of vehicle state parameters comprising the received measurement data is indicative of a physical state parameter of the vehicle.

9. A method according to claim 8 wherein the physical state parameter comprises one or more of: the vehicle's position, the vehicle's orientation, one or more time derivatives of the vehicle's position, one or more time derivatives of the vehicle's orientation, a lane position of the vehicle, and a collision-risk of the vehicle.

10. A method according to claim 1 wherein at least one of the of vehicle state parameters comprising the received measurement data is indicative of a control state parameter of the vehicle.

11. A method according to claim 10 wherein the control state parameter comprises one or more of: a status of the vehicle's steering apparatus, a status of the vehicle's acceleration system, a status of the vehicle's driving brake system, a status of the vehicle's clutch system, a status of the vehicle's gearing system, a status of the vehicle's turn signal system, a status of the vehicle's hazard light system, a status of the vehicle's windshield wiper system, a status of one or more of the vehicle's entertainment systems, a status of the vehicle's parking brake vehicle, a status of the vehicle's fuel gauge system, a throttle angle of the vehicle, an engine speed of the vehicle, a turbine speed of the vehicle, an engine torque of the vehicle, a driven wheel speed of the vehicle, a drive wheel speed of the vehicle, a status of the vehicle's fuel flow meter system, a status of the vehicle's fuel injection system, and an engine piston firing period of the vehicle.

12. A method according to claim 1 wherein at least one the of vehicle state parameters comprising the received reference data is indicative of a physical state parameter of the vehicle.

13. A method according to claim 12 wherein the physical state parameter comprises one or more of: the vehicle's position, the vehicle's orientation, one or more time derivatives of the vehicle's position, one or more time derivatives of the vehicle's orientation, a lane position of the vehicle, and a collision-risk of the vehicle.

14. A method according to claim 1 wherein at least one of the of vehicle state parameters comprising the received reference data is indicative of a control state parameter of the vehicle.

15. A method according to claim 14 wherein the control state parameter comprises one or more of: a status of the vehicle's steering apparatus, a status of the vehicle's acceleration system, a status of the vehicle's driving brake system, a status of the vehicle's clutch system, a status of the vehicle's gearing system, a status of the vehicle's turn signal system, a status of the vehicle's hazard light system, a status of the vehicle's windshield wiper system, a status of one or more of the vehicle's entertainment systems, a status of the vehicle's parking brake vehicle, a status of the vehicle's fuel gauge system, a throttle angle of the vehicle, an engine speed of the vehicle, a turbine speed of the vehicle, an engine torque of the vehicle, a driven wheel speed of the vehicle, a drive wheel speed of the vehicle, a status of the vehicle's fuel flow meter system, a status of the vehicle's fuel injection system, and an engine piston firing period of the vehicle.

16. A method according to claim 1 wherein receiving reference data comprises receiving reference data from an automated driving algorithm applied to the at least a portion of the driving trip.

17. A method according to claim 1 wherein receiving reference data comprises receiving reference data representing how a population of drivers executes the at least a portion of the driving trip.

18. A method according to claim 1 wherein receiving reference data comprises receiving reference data representing how a known human driver executes the at least a portion of the driving trip.

19. A method according to claim 1 wherein receiving reference data comprises receiving reference data representing execution of the at least a portion of the driving trip in a fuel-consumption optimized manner.

20. A method according to claim 1 wherein receiving reference data comprises receiving reference data representing execution of the at least a portion of the driving trip in a collision-risk minimized manner.

21. A method according to claim 1 wherein one or more of the vehicle state parameters comprising the reference data are of the same type as one or more vehicle state parameter comprising the measurement data.

22. A method according to claim 21 further comprising:
synchronizing the received measurement data and the received reference data.

23. A method according to claim 1 further comprising:
standardizing the received measurement data and the received reference data.

24. A method according to claim 23 wherein standardizing the received measurement data and the received reference data comprises standardizing the received measurement data and the received reference data with respect to one or more of: the number of vehicle state parameters, the type of vehicle state parameters, units of measurement for one or more the vehicle state parameters, data sources for one or more vehicle state parameters, and sensors used to measure the one or more vehicle state parameters.

25. A method according to claim 1 wherein receiving the measurement data at a computer comprises receiving the measurement data at the computer from more than one measurement sensor for at least one vehicle state parameter and applying a data fusion technique to determine the value of the vehicle state parameter.

26. A method according to claim 25 wherein the data fusion technique comprises one or more of: applying a Kalman filter, applying an unscented Kalman filter, applying a Bayesian data fusion technique, and applying a Monte Carlo technique.

27. A method according to claim 1 wherein the driving trip is comprised at least in part of one or more driving tasks.

28. A method according to claim 27 wherein at least one of the one or more driving tasks comprising the driving trip is characterized by one or more of: a start time, a start location, an end time, an end location, one or more intermediate locations, one or more roadway parameters, and one or more environmental factors.

29. A method according to claim 27 wherein the one or more roadway parameters comprise one or more of: a radius of curvature, a speed limit, a number of driving lanes comprising the roadway, a width of a driving lane comprising the roadway, a geographic location, and a measure of straightness of the roadway.

30. A method according to claim 25 wherein the one or more environmental factors comprise one or more of: the presence of another vehicle, the presence of a pedestrian, the presence of an obstacle in the roadway, a climate condition, and a temperature.

31. A method according to claim 25 wherein at least one of the one or more driving tasks comprising the driving trip is associated with a driving-task classification.

32. A method according to claim 31 wherein the driving-task classification comprises one or more of: a straightaway, a straightway with a fixed obstacle, a straightaway with another vehicle moving in a fixed direction, a straightaway with another vehicle moving in an unpredictable pattern, a straightaway with two or more vehicles moving in a fixed direction, a straightaway with two or more vehicles moving in an unpredictable pattern, a curve with an approximately constant radius of curvature, a curve with an approximately constant radius of curvature and with a fixed obstacle in the roadway, a curve with an approximately constant radius of curvature with another vehicle moving in a fixed direction, a curve with an approximately constant radius of curvature with another vehicle moving in an unpredictable pattern, a curve with an approximately constant radius of curvature with two or more vehicles moving in a fixed direction, and a curve with an approximately constant radius of curvature with two or more vehicles moving in an unpredictable pattern

33. A method according to claim 31 wherein at least one of the vehicle state parameters indicated by the received reference data is determined based at least in part on the driving-task classification of one or more of the driving tasks comprising the driving trip.

34. A method according to claim 31 wherein the determined metric of comparison is determined based at least in part on the driving-task classification of one or more of the driving tasks comprising the driving trip.

35. A method according to claim 34 wherein at least one of the one or more driving tasks comprising the driving trip is classified as a straightaway; wherein the received reference data comprises at least in part one or more of: lane tracking data and steering wheel deviation data; and wherein the determined metric of comparison comprises at least in part one or more of: a lane tracking metric and a steering-wheel deviation metric.

36. A method according to claim 34 wherein at least one of the one or more driving tasks comprising the driving trip is classified as a curve; wherein the received reference data comprises at least in part one or more of: radius of curvature data, lane tracking data, and steering wheel deviation data; and wherein the determined metric of comparison comprises at least in part one or more of: radius-of-curvature deviation metric, a lane tracking metric, and a steering-wheel deviation metric.

37. A method according to claim 25 wherein the received measurement data is separated into one or more partitions based at least in part upon one or more driving tasks comprising the driving trip.

38. A method according to claim 25 wherein the received reference data is separated into one or more partitions based at least in part upon one or more driving tasks comprising the driving trip.

39. A method according to claim 25 wherein each of the at least one driving tasks is associated with at least one of the at least one determined metrics of comparison.

40. A method according to claim 1 further comprising:
receiving, at the computer, environmental-factor data, the environmental-factor data being indicative of one or more conditions extrinsic to the vehicle that may impact driver performance.

41. A method according to claim 40 wherein receiving environmental-factor data at the computer comprises receiving an environmental-factor signal at the computer, the environmental-factor signal being comprised of one or more time series functions of environmental factors, wherein the environmental factors correspond to conditions extrinsic to the vehicle that may impact driver performance.

42. A method according to claim 40 wherein the environmental factors comprise one or more of: the presence of another vehicle, the presence of a pedestrian, the presence of an obstacle in the roadway, a climate condition, and a temperature.

43. A method according to claim 40 further comprising:
identifying one or more driving tasks based at least in part on the received environmental-factor data, the driving tasks being indicative of a segment of the driving trip with a common environmental factor.

44. A method according to claim 43 wherein the one or more identified driving tasks being indicative of a segment of the driving trip with a common environmental factor are further classified according to driving-task classification.

45. A method according to claim 4:
wherein receiving the measurement data at a computer comprises receiving a measurement signal at a computer, the measurement signal being comprised of one or more time series functions of vehicle state parameters corresponding to a driver operating a vehicle during a driving trip;
wherein receiving a reference signal at a computer comprises receiving a reference signal at a computer containing a reference signal portion corresponding to a driving task of interest; and
wherein determining, at the computer, a metric of comparison based at least in part on the received measurement signal and the received reference data comprises at least in part:
identifying within the received measurement signal at least one measurement signal portion corresponding to the driving task of interest;
calculating one or more measurement driving task characteristics by analyzing the identified at least one measurement signal portion corresponding to the driving task of interest;
identifying within the received reference signal at least one reference signal portion corresponding to the driving task of interest;
calculating one or more reference driving task characteristics by analyzing the identified at least one reference signal portion corresponding to the driving task of interest; and
determining a driving-task distance between the calculated reference driving task characteristics and the calculated measurement driving task characteristics, wherein the driving-task distance represents a discrepancy between the calculated reference driving task characteristics and the calculated driving task characteristics.

46. A method according to claim 45 wherein the determined driving-task distance between the calculated reference driving task characteristics and the calculated measurement driving task characteristics comprises one or more of: a linear distance, a Euclidean distance, a weighted Euclidean distance, and an epsilon insensitive distance.

47. A method according to claim 5:
wherein receiving the measurement data comprises receiving one or more measurement driving task characteristics at the computer, the one or more measurement driving task characteristics each being indicative of one or more vehicle state parameters during execution of a driving task by the driver;
wherein receiving one or more reference driving task characteristics comprises receiving one or more reference driving task characteristics corresponding to a driving task of interest, and
wherein determining, at the computer, a metric of comparison based at least in part on the received measurement signal and the received reference data comprises at least in part:
identifying within the received measurement signal at least one measurement signal portion corresponding to the driving task of interest;
calculating one or more measurement driving task characteristics by analyzing the identified at least one measurement signal portion corresponding to the driving task of interest; and
determining a driving-task distance between the received reference driving task characteristics and the calculated measurement driving task characteristics, wherein the driving-task distance represents a discrepancy between the received reference driving task characteristics and the calculated driving task characteristics.

48. A method according to claim 47 wherein receiving one or more reference driving task characteristics corresponding to a driving task of interest comprises receiving the one or more reference driving task characteristics from a database.

49. A method according to claim 47 wherein the determined driving-task distance between the received reference driving task characteristics and the calculated measurement driving task characteristics comprises one or more of: a linear distance, a Euclidean distance, a weighted Euclidean distance, and an epsilon insensitive distance.

50. A method according to claim 46 wherein the calculated reference driving task characteristic and the calculated measurement driving task characteristic are each comprised of a driving path.

51. A method according to claim 47 wherein the calculated reference driving task characteristic and the calculated measurement driving task characteristic are each comprised of a driving path.

52. A method according to claim 4:
wherein receiving the measurement data at a computer comprises receiving a measurement signal at a computer, the measurement signal being comprised of one or more time series functions of vehicle state parameters corresponding to a driver operating a vehicle during a driving trip; and
wherein determining, at the computer, a metric of comparison based at least in part on the received measurement signal and the received reference signal comprises at least in part: determining a signal difference function between the received reference signal and the received measurement signal, the signal difference function representing a discrepancy between the received measurement signal and the received reference signal.

53. A method according to claim 52 wherein the signal difference function between the received reference signal and the received measurement signal comprises a vector difference between the received reference signal and the received measurement signal.

54. A method according to claim 52 wherein the signal difference function comprises a weighted vector difference between the received reference signal and the received measurement signal.

55. A method according to claim 52 wherein determining, at the computer, a metric of comparison based at least in part on the measurement signal and the reference signal further comprises at least in part: determining a signal difference metric based at least in part on the determined signal difference function, the determined signal difference metric representing a quantity associated with a particular interval of the determined signal difference function.

56. A method according to claim 55 wherein the determined signal difference metric comprises a magnitude of the determined signal difference function evaluated on a particular interval.

57. A method according to claim 55 wherein the particular interval of the determined signal difference function comprises one or more of: an interval of the determined signal difference function between two points in time, an interval of the determined signal difference function between two positions of the vehicle in space, an interval of the determined signal difference function corresponding to one or more driving tasks, and an interval of the determined signal difference function corresponding to one or more driving trips.

58. A method according to claim 1, wherein the at least one determined metric of comparison comprises two or more determined metrics of comparison, and further comprising:
determining, at the computer, a composite metric of comparison from the two or more determined metrics of comparison, the composite metric of comparison indicative of an assessment of the driver operating the vehicle relative to a standard of performance for two or more portions of the driving trip.

59. A method according to claim 58 wherein determining a composite metric of comparison comprises determining one or more of: an average of the two or more metrics of comparison, a weighted average of the two or more metrics of comparison, a non-linear weighted average of the two or more metrics of comparison, and a weighted average followed by a non-linear functional reduction of the two or more metrics of comparison.

60. A computer program product embodied in a non-transitory medium and comprising computer-readable instructions that, when executed by a suitable computer, causes the computer to perform a method for assessing driver performance relative to a standard of performance, the method comprising;
receiving measurement data at a computer, the measurement data indicative of one or more vehicle state parameters corresponding to a driver operating the vehicle during a driving trip;
receiving reference data at the computer, the reference data indicative one or more vehicle state parameters corresponding to a standard of performance for the vehicle during at least a portion of the driving trip; and
determining, at the computer, a metric of comparison based at least in part on the received measurement signal and the received reference data, the metric of comparison indicative of an assessment of the driver operating the vehicle relative to the standard of performance.

61. A system for assessing driver performance relative to a standard of performance, the system comprising:
a measurement signal generator, the measurement signal generator being capable of generating a measurement signal that provides measured values for one or more parameters of a vehicle's state while a driver is operating the vehicle on a driving trip;
a reference signal generator, the reference signal generator being capable of generating a reference signal that, for at least a portion of the driving trip, provides values for one or more parameters of a vehicle's state while it is being driving in accordance with a standard of performance; and
a scorer, the scorer being capable of determining a metric of comparison between the reference signal and the measurement signal, the metric of comparison being indicative of how the driver executed the one or more driving tasks with the vehicle relative to the standard of performance,
wherein the scorer is communicably connected to the reference signal generator and the measurement signal generator such that the scorer receives the reference signal and the measurement signal.
